(19) United States
(12) Patent Application Publication
(10) Pub. No.: US 2007/0030256 A1
(43) Pub. Date: Feb. 8, 2007

(54) Display apparatus and display method

(75) Inventors: Kazuhiro Akaike, Kanagawa (JP); Takeshi Hizume, Kanagawa (JP); Yukiko Onodera, Kanagawa (JP)

Correspondence Address: ROBERT J. DEPKE;LEWIS T. STEADMAN, ROCKEY, DEPKE, LYONS AND KITZINGER, LLC, SUITE 5450 SEARS TOWER, CHICAGO, IL, 60606-6306, US

(73) Assignee: SONY CORPORATION

(21) Appl. No.: 11/495,785

(22) Filed: Jul. 28, 2006

(30) Foreign Application Priority Data
Aug. 2, 2005 (JP) P2005-224384

(51) Int. Cl. G09G 5/00

(52) U.S. Cl. 345/173

(57) ABSTRACT

A display apparatus includes a display section, a touch panel on the display surface of the section to allow the user to specify a desired position on the displayed image being displayed on the section by pressing a pointer against it, a display control section causes a plurality of indicators to be displayed on the section for allowing the user to select one of them via the panel and a notifier section notifies the user of the indicator selected from them. The notifier section notifying the user of the selection of a indicator when the indicator of them being displayed on the section is selected by pressing the pointer against the panel, and the control section is adapted to finalize the selection by the user of a indicator when the pointer selecting the indicator is moved away from the panel after selecting it by being pressed against the panel.

### CROSS REFERENCES TO RELATED APPLICATIONS

The present invention contains subject matter related to Japanese Patent Application JP 2005-224384 filed in the Japanese Patent Office on Aug. 2, 2005, the entire contents of which being incorporated herein by reference.

### BACKGROUND OF THE INVENTION

1. Field of the Invention

The present invention relates to a display apparatus and a display method. For example, the present invention can suitably be applied to a display apparatus having a touch panel.

2. Description of the Related

A display apparatus including a touch panel that a user can operates for input operations by touching the surface thereof have become popular in recent years. Such display apparatus include, for example, those of automatic ticket vending machines for trains that have a relatively large display section (e.g., tens of several centimeters in diagonal) and each ticket buyer can buy a ticket by pressing one of the indicators being displayed on the display section, that may be in the form of a button or some other icon, by means of a fingertip and those of PDAs (Personal Digital Assistants) that have a relatively small display section (e.g., several centimeters in diagonal) and the user selects one of the indicators being displayed on the display section by means of the pen point of a touch pen to have the PDA execute the process corresponding to the indicator being displayed and selected (see, for example, Jpn. Pat. Appln. Laid-Open Publication No. 2001-034402 [FIG. 7]).

### SUMMARY OF THE INVENTION

Meanwhile, when selecting one of the indicators being displayed on the display section of such a display apparatus by means of a fingertip, a user may find it difficult to recognize what indicator he or she is selecting if each of the indictors is smaller than the finger pad by which the user is pressing.

For this reason, when each of the indicators being displayed on the display section of such a display apparatus are smaller than the finger pad of a finger of human being, it is indispensable to use a touch pen for an input operation.

However, such a touch pen has to be provided apart from the display apparatus. In other words, it is no longer possible for anyone to perform an input operation when the touch pen is missing.

In short, the convenience of a display apparatus having a touch panel will be improved remarkably when the user can perform an input operation with ease regardless of the size of the indicators being displayed on the display section of such a display apparatus.

In view of the above-identified circumstances, it is therefore desirable to provide a display apparatus and a display method that remarkably improve the facility of operation of the touch panel belonging to the display apparatus.

In an aspect of the present invention, there is provided a display apparatus including: a display section; a touch panel arranged on the display surface of the display section to allow the user to specify a desired position on the displayed image being displayed on the display section by pressing a pointer against it; a display control section that causes a plurality of indicators to be displayed on the display section so as to allow the user to select one of them by way of the touch panel; and a notifier section that notifies the user of the indicator selected from the plurality of indicators; the notifier section being adapted to notify the user of the selection of one of the indicators when the indicator of plurality of indicators being displayed on the display section is selected by pressing the pointer against the touch panel, and the display control section being adapted to finalize the selection by the user of one of the indicators when the pointer selecting the indicator is moved away from the touch panel after selecting it by being pressed against the touch panel.

As described above, according to the aspect of the present invention, it is now possible to make the user recognize the indicator he or she has selected from the plurality of indicators displayed on the display section by means of a pointer as the user is notified of the selected indicator. Additionally, the user can select an indicator by pressing it by means of a pointer and finalize the selection of the indicator by moving away the pointer from it. In other words, the user can select an indicator and finalize the selection by means of a single action of pressing the touch panel.

Thus, according to the aspect of the present invention, the user can recognize the indicator that he or she has pressed by means of a pointer as the user is notified of the indicator selected from the plurality of indicators being displayed on the display section by way of the touch panel. Additionally, the user can select an indicator and finalize the selection by means of a single action of pressing the touch panel as he or she selects the indicator by pressing a pointer against an indicator on the touch panel and finalizes the selection by leaving the pointer. Thus, as a result, with a display apparatus and a display method according to an embodiment of the present invention, the convenience of the display apparatus having a touch panel will be improved remarkably because the user can perform an input operation with ease regardless of the size of the indicators being displayed on the display section of such a display apparatus.

The nature, principle and utility of the invention will become more apparent from the following detailed description when read in conjunction with the accompanying drawings in which like parts are designate by like reference numerals or characters.

### BRIEF DESCRIPTION OF THE DRAWINGS

In the accompanying drawings:

FIGS. 1A through 1C schematically illustrate an image viewing apparatus, showing the overall configuration thereof;

FIG. 2 is a schematic block diagram of the image viewing apparatus of FIGS. 1A through 1C, showing the circuit configuration thereof;

FIGS. 3A through 3E schematically illustrate how to operate an image viewing apparatus according to the first embodiment (1);

FIGS. 4A through 4D schematically illustrate how to operate an image viewing apparatus according to the first embodiment (2);

FIG. 5 is a flowchart of the fingertip pressing process sequence of the first embodiment;

FIGS. 6A and 6B schematically illustrate how the distance of movement is determined.

FIG. 7 is a flowchart of the fingertip moving process sequence of the first embodiment;

FIG. 8 is a flowchart of the fingertip moving away process sequence of the first embodiment;

FIGS. 9A through 9G schematically illustrate how to operate an image viewing apparatus according to second embodiment (1);

FIGS. 10A through 10G schematically illustrate how to operate an image viewing apparatus according to second embodiment (2);

FIGS. 11A through 11H schematically illustrate how to operate an image viewing apparatus according to second embodiment (3);

FIGS. 12A through 12F schematically illustrate how to operate an image viewing apparatus according to second embodiment (4);

FIG. 13 is a flowchart of the fingertip pressing process sequence of the second embodiment;

FIG. 14 is a flowchart of the fingertip moving process sequence of the second embodiment;

FIG. 15 is a flowchart of the fingertip moving away process sequence of the second embodiment;

FIG. 16 is a flowchart of the timer operating process sequence;

FIGS. 17A through 17E schematically illustrate how to operate an image viewing apparatus according to another embodiment (1);

FIGS. 18A through 18E schematically illustrate how to operate an image viewing apparatus according to another embodiment (2);

FIGS. 19A through 19E schematically illustrate how to operate an image viewing apparatus according to another embodiment (3); and

FIGS. 20A through 20E schematically illustrate how to operate an image viewing apparatus according to another embodiment (4).

### DETAILED DESCRIPTION OF THE PREFERRED EMBODIMENTS

Now, the present invention will be described in greater detail by referring to the accompanying drawings that illustrate preferred embodiments of the invention.

### (1) First Embodiment

(1-1) External Configuration of Image Viewing Apparatus

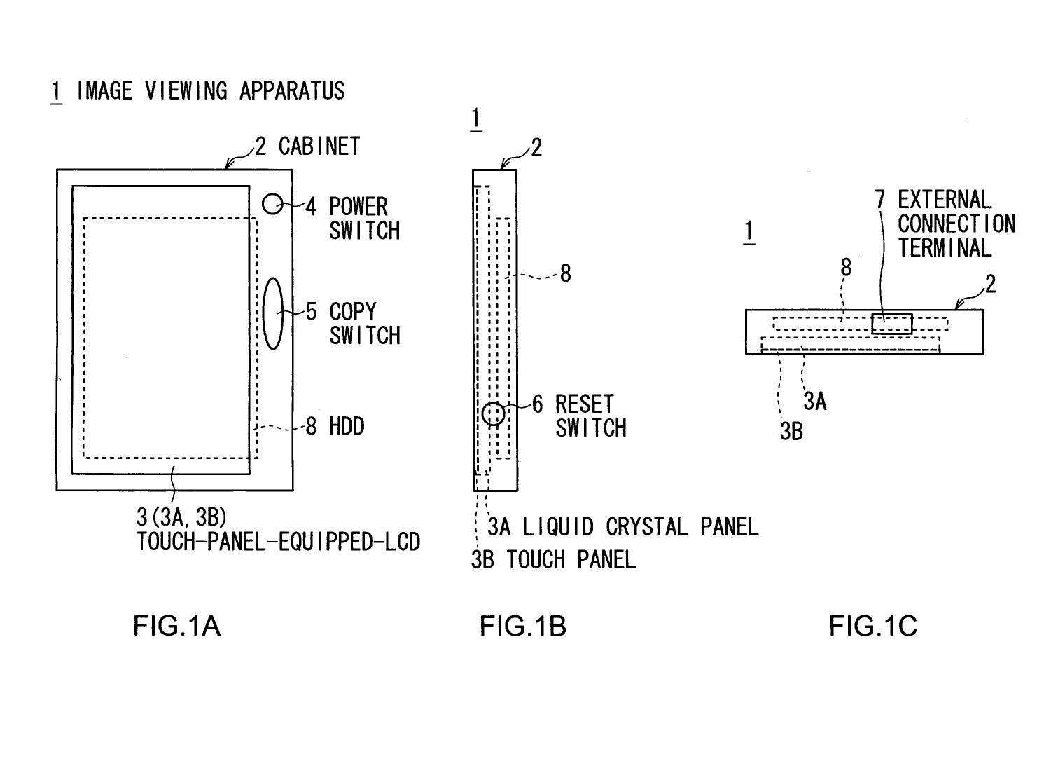

FIGS. 1A through 1C schematically illustrate an image viewing apparatus, showing the overall configuration thereof. In FIGS. 1A through 1C, 1 generally denotes the image viewing apparatus. The image viewing apparatus 1 includes a cabinet 2 showing a flat and rectangular profile that can be held by a single hand (so-called palm size)

The cabinet 2 has on the surface thereof an LCD (Liquid Crystal Display) 3 that is equipped with a rectangular plate-like touch panel. As shown in FIGS. 1B and 1C, the touch-panel-equipped-LCD 3 is formed by applying a transparent touch panel 3B to the surface of a liquid crystal panel 3A. As a fingertip is pressed against the touch panel 3B, then, the image viewing apparatus 1 recognizes the position in the image being displayed on the display panel 3A that is specified by the user according to the position pressed by the fingertip. Note that the touch panel 3B is of the electrostatic capacity type that is suited for press operations (press and leave operations) using a fingertip.

The cabinet 2 also has on the surface thereof a power switch 4 for turning on/off the power supply of the image viewing apparatus 1 and a copy switch 5, which will be described in greater detail hereinafter, in addition to the touch-panel-equipped-LCD 3. Additionally, the cabinet 2 is provided on lateral surfaces thereof with a reset switch 6 to be used when restarting the system of the image viewing apparatus 1 and an external connection terminal 7 for connecting an external apparatus to the image viewing apparatus 1.

Thus, for example, as a digital still camera (not shown) is connected to the external connection terminal 7 by way of a predetermined cable and the copy switch 5 is depressed, the image viewing apparatus 1 reads out the image data recorded in the digital still camera and copies them to the hard disk drive 8 contained in it.

Additionally, the image viewing apparatus 1 retrieves any of the image data copied to the hard disk drive 8 in response to an operation of pressing the touch-panel-equipped-LCD 3 and displays the image of the retrieved image data on the touch-panel-equipped-LCD 3.

Thus, since the image viewing apparatus 1 is portable and includes a hard disk drive 8 for recording image data read out from an external apparatus and a touch-panel-equipped-LCD 3 for displaying images of the image data recorded in the hard disk drive 8, it is possible for the user to display the image he or she picked up by means of a digital still camera on the touch-panel-equipped-LCD 3 of the image viewing apparatus 1 on site without making any effort for displaying it on the display screen of a personal computer or printing it.

(1-2) Circuit Configuration of Image Viewing Apparatus

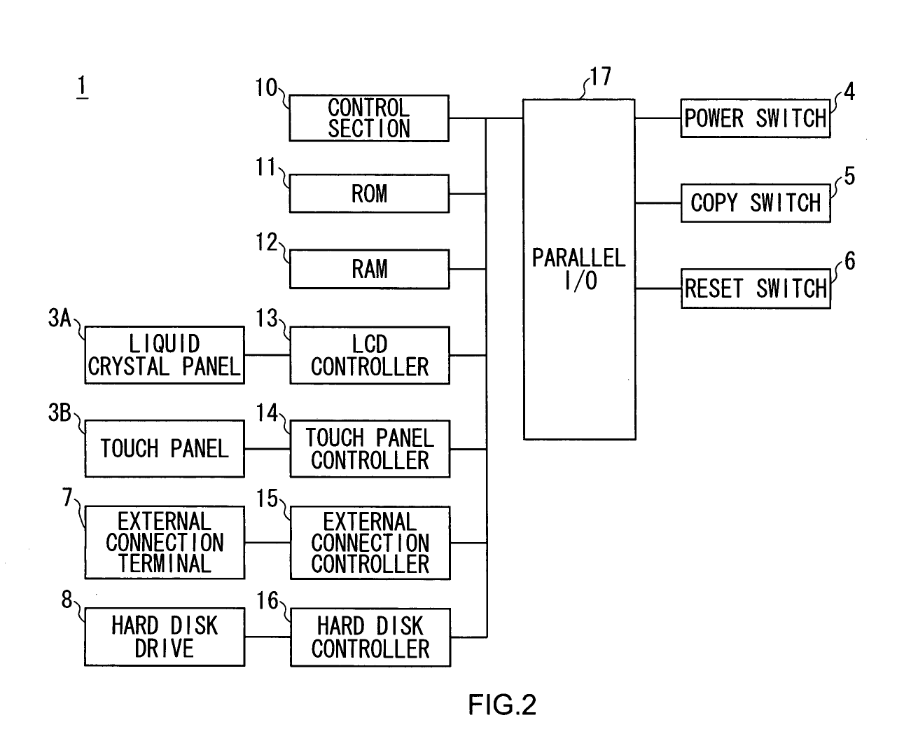

Now, the circuit sections of the image viewing apparatus 1 arranged in the inside of the latter will be described below by referring to FIG. 2. In the image viewing apparatus 1, a control section 10 reads out the program stored in a ROM (Read Only Memory) 11 to a RAM (Random Access Memory) 12. The control section 10 develops the program it reads out on the RAM 12. Then, the control section 10 controls an LCD controller 13, touch panel controller 14, external connection controller 15 and hard disk controller 16 connected to it and executes various processes according to the developed program.

The LCD controller 13 displays images on the liquid crystal panel 3A by controlling the liquid crystal panel 3A according to the directions from the control section 10. The touch panel controller 14 recognizes the coordinates that correspond to the position on the touch panel 3B pressed by the user and transmits information on the coordinates to the control section 10. The external connection controller 15 controls the external apparatus connected to the external connection terminal 7 according to the directions from the control section 10 and exchanges data with the external apparatus. The hard disk controller 16 reads data from and write data to the hard disk drive 8 by controlling the hard disk drive 8 according to the directions from the control section 10.

The control section 10 is also connected to the power switch 4, the copy switch 5 and the reset switch 6 by way of a parallel I/O 17, which parallel I/O 17 receives signals from the power switch 4, the copy switch 5 and the reset switch 6 as inputs and transmits them to the control section 10.

(1-3) Image Viewing Operation

Now, the image viewing operation of the image viewing apparatus 1 will be described in detail below. Assume here, for instance, images picked up by means of an external digital still camera are recorded in the hard disk drive 8 and date information showing the dates when the images are picked up by means of the digital still camera (and hence the dates when the image data are prepared) is added to the image data of the images.

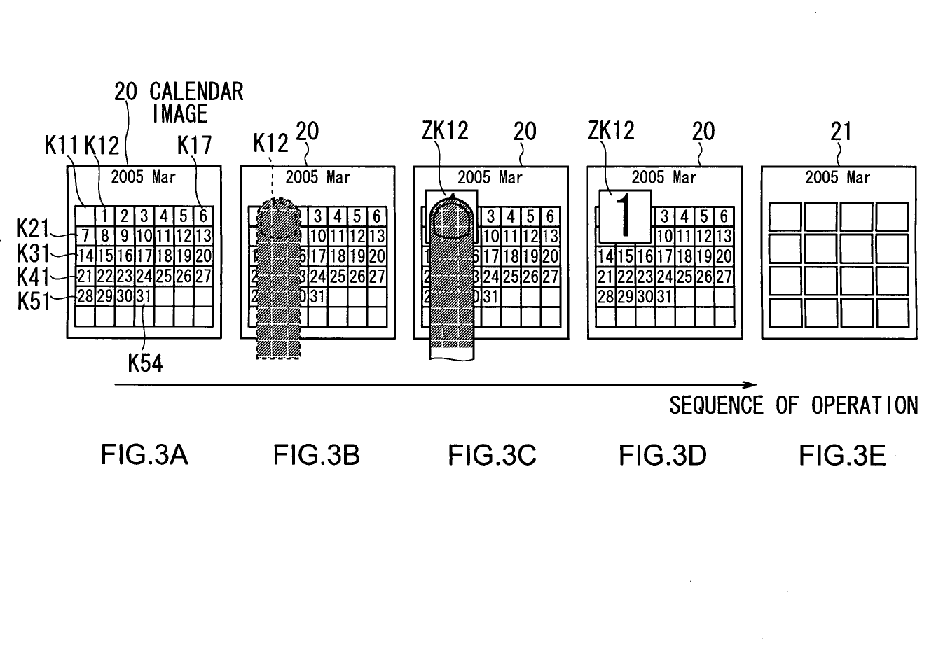

Firstly, the image viewing apparatus 1 displays a calendar image 20 as illustrated in FIG. 3A on the touch-panel-equipped-LCD 3. The calendar image 20 shows 6 rows and 7 columns of blocks K, or a total of 42 blocks K, and the days of the month are arranged in the blocks.

Because a month has 31 days at most, up to 31 blocks K are filled with the numerals of the days of the month on the calendar image 20 out of the 42 blocks K. The columns of the calendar image 20 correspond to the days of the week, or Monday through Sunday. Thus, all the days of the month are shown on the calendar image 20 that has 42 blocks K with the same days of the week arranged respectively on the same columns. Each of the 42 blocks K is identified by a combination of a row number and a column number (to be referred to as block number hereinafter). More specifically, the block K on the first row and the first column is referred to as block K11, the block K on the first row and the second common is referred to as block K12 and so on. Similarly, the block K on the second row and the first column is referred to as block K21 and the block K on the third row and the first column is referred to as block K31.

Note that the calendar images 20 of FIGS. 3A to 3E respectively correspond to March, 2005. Thus, “1” is filled in the block K12 to show the first of May and “2” is filled in the block K13 to show the second of May, while “6” is filled in the block K17 to show the sixth of May and “7” is filled in the block K21 to show the seventh of May. Similarly, “14” is filled in the block K31 to show the fourteenth of May and “21” is filled in the block K41 to show the twenty first of May, while “28” is filled in the block K51 to show the twenty eighth of May and “31” is filled in the block K54 to show the thirty first of May.

Then, as one of the blocks K (the block K12 through the block K54) that indicate the days of the month shown in the calendar image 20 is selected by the user by means of a fingertip and by way of the touch panel 3B, the image viewing apparatus 1 can retrieve the image data to which the date information of the date that corresponds to the selected block is added from the hard disk drive 8.

Meanwhile, the image viewing apparatus 1 has such a small size that the user can hold it by a single hand and hence the display area of the touch-panel-equipped-LCD 3 is quite limited. Thus, each of the 42 blocks K that are displayed on the touch-panel-equipped-LCD 3 is smaller than the finger pad of a finger of the user. Then, as a result, the block K selected by the user by means of a fingertip may not be visible to the user because it is hidden by the fingertip as shown in FIG. 3B.

For this reason, the image viewing apparatus 1 is so devised that the user can select a block K having a display area smaller than the area of the finger pad of a finger of the user without difficulty. More specifically, the user may select the block K12 and press the display area of the block K12 (at the inside of the block K12) by means of a fingertip and by way of the touch panel 3B.

Then, as a result, the image viewing apparatus 1 recognizes that the display region of the block K12 is pressed by the user by means of a fingertip and by way of the touch panel controller 14 and then displays an enlarged block ZK12 of the block K12 concentrically on the block K12 as a superimposed image on the touch-panel-equipped-LCD 3 as shown in FIG. 3C. Note that the display area of the enlarged block ZK12 is larger than the area of the finger pad of a finger of the user.

As the image viewing apparatus 1 recognizes that the display region of the block K12 is pressed by the user by means of a fingertip, it displays an enlarged block ZK12 concentrically on the block K12 as a superimposed image with a size large enough to come out of the fingertip of the user and indicate that the block K12 is selected. Then, the user is able to assume that the block K12 (the first) is correctly selected on the basis of the display position of the enlarged block ZK12 and part of the numeral “1” shown in the enlarged block ZK12.

In this way, after displaying the enlarged block ZK12, as the fingertip of the user is moved away from the touch panel 3B as shown in FIG. 3D, the image viewing apparatus 1 recognizes that the fingertip of the user is moved away from the display region of the block K12 by way of the touch panel controller 14 and, at the same time, determines that the block K12 is selected by the user.

Then, the image viewing apparatus 1 retrieves the image data to which the date information corresponding to the block K12 (or May 1, 2005) is added from the hard disk drive 8 and displays the retrieved image data on the touch-panel-equipped-LCD 3 as image viewing image 21 showing thumbnail images as illustrated in FIG. 3E.

Thus, the image viewing apparatus 1 can perform all the operations from the operation of selecting a block K through that of determining the selected block K in response to a single operation (to be also referred to as basic operation hereinafter) by the user of pressing the display region of a desired block K from the calendar image 20 by means of a fingertip and removing the fingertip. Such an image viewing operation is a very simple one to the user.

If, on the other hand, the user wants to select the block K22 (the eighth) and tries to press the display region of the block K22 but erroneously presses the display region of the block K12 (the first) that is on the row right above the row of the block K22 and selects the block K12, the user operates the image viewing apparatus 1 to correct the selection of the block K (to be also referred to as changing operation hereinafter).

More specifically, as the user understands that he or she has erroneously selected the block K12 by seeing an enlarged block ZK12 that is being displayed, the user moves the fingertip from the display region of the block K12 to the display region of the block K22, keeping the fingertip pressing the touch panel 3B.

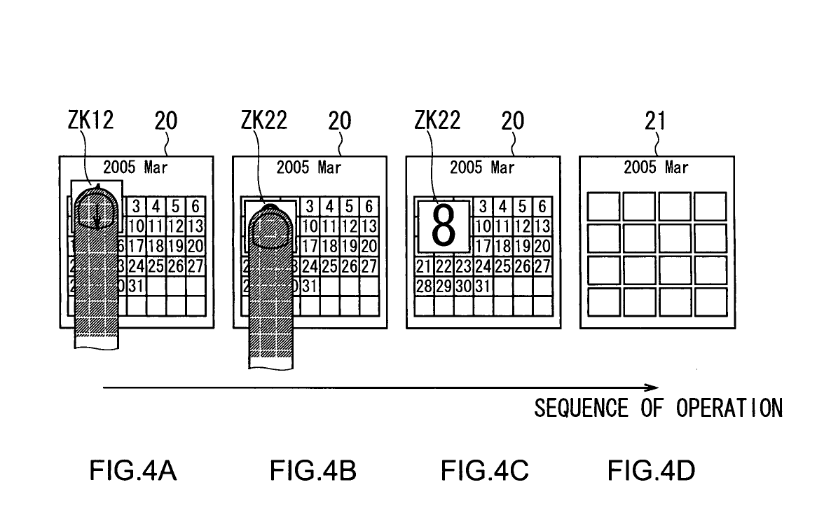

Then, as a result, the image viewing apparatus 1 recognizes that the fingertip of the user is moved from the display region of the block K12 to the display region of the block K22. Then, it cancels the display of the enlarged block ZK12 and, at the same time, displays an enlarged block ZK22, which is an enlarged image of the block K22, concentrically on the block K22 as a superimposed image in a manner as illustrated in FIG. 4B. As a result, the image viewing apparatus 1 can make the user assume with ease that the selected block K is moved from the block K12 to the block K22 or the selected block K is switched from the block K12 to the block K22.

After displaying the enlarged block ZK22, as the fingertip of the user pressing the touch panel 3B is moved away from the touch panel 3B as illustrated in FIG. 4C, the image viewing apparatus 1 recognizes that the fingertip of the user is moved away from the display region of the block K22 by way of the touch panel controller 14 and determines that the block K22 is the block K selected by the user.

Then, the image viewing apparatus 1 retrieves the image data to which the date information corresponding to the block K22 (or May 8, 2005) is added from the hard disk drive 8 and displays the retrieved image data on the touch-panel-equipped-LCD 3 as image viewing image 21 showing thumbnail images as illustrated in FIG. 4D.

Thus, the image viewing apparatus 1 can perform all the operations necessary for changing the selection of a block K in response to a single operation by the user of moving the fingertip pressing the touch panel 3B to the display region of a desired block K. Such a changing operation is a very simple one to the user.

(1-4) Operation Process Sequence of Image Viewing Operation

Now, the operation process sequence of the image viewing apparatus 1 in an image viewing operation will be described in greater detail in terms of the sequence of an event process that takes place when a fingertip is pressed (to be referred to as fingertip pressing process sequence hereinafter), the sequence of an event process that takes place when a pressing fingertip is moved (to be referred to as fingertip moving process sequence hereinafter) and the sequence of an event process that takes place when the pressing fingertip is moved away (to be referred to as fingertip moving away process sequence hereinafter) . Note that the control section 10 of the image viewing apparatus 1 executes any of these operation process sequences according to the program installed in the ROM 11. As an example, the operation process sequence will be described below on an assumption that a calendar image 20 that corresponds to May, 2005is displayed on the touch-panel-equipped-LCD 3.

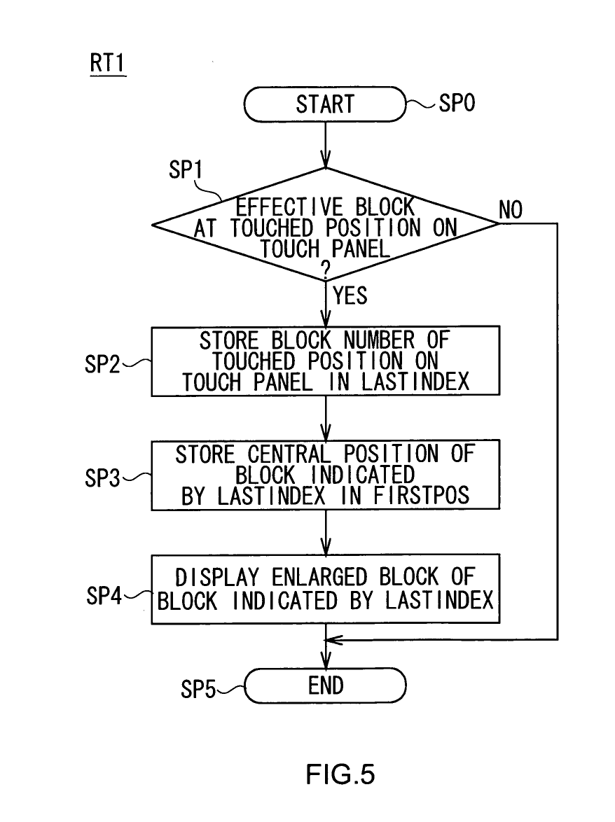

Firstly, the fingertip pressing process sequence RT1 will be described by referring to the flowchart of FIG. 5. Note that, in the following description, the variable storing the central position of the block K on the touch panel 3B that is pressed by a fingertip (to be referred to as initial pressed position hereinafter) is expressed by FirstPos and the variable storing the block number of the block K where the initial pressed position is found is expressed by LastIndex, while the variable storing the distance by which the fingertip pressing the touch panel 3B is moved in terms of number of blocks and the variable storing the block number of the block where the position to which the fingertip pressing the touch panel 3B is moved is located (to be referred to as current pressing position hereinafter) are expressed respectively by DiffIndex and CurrentIndex and the variable storing the block number of the block where the position at which the fingertip is moved away from the touch panel 3B is located (to be referred to as fingertip moving away position hereinafter) is expressed by LastFocusIndex.

As shown in FIG. 5, as the control section 10 of the image viewing apparatus 1 recognizes by way of the touch panel controller 14 that the user presses the touch panel 3B by means of a fingertip, it starts the fingertip pressing process sequence RT1 at Step SP0 and then proceeds to the next step, or Step SP1.

In Step SP1, the control section 10 determines if there is a block K showing a numeral that indicates a date (to be referred to as effective block K hereinafter) that is found in the initial pressed position or not. If the answer to the question in Step SP1 is negative, it means that the user presses a part of the displayed image other than the effective blocks K (blocks K11 through K54 in the case of May, 2005). Then, the control section 10 determines that the user is not selecting an effective block K and goes to Step SP5 to end the fingertip pressing process sequence RT1.

If, on the other hand, the answer to the question in Step SP1 is positive, it means that the user is selecting an effective block K and then the control section 10 proceeds to Step SP2.

In Step SP2, the control section 10 stores the block number of the block K where the initial pressed position is found in LastIndex and proceeds to Step SP3. In Step SP3, the control section 10 stores the central position of the block K indicated by the block number stored in LastIndex in FirstPos.

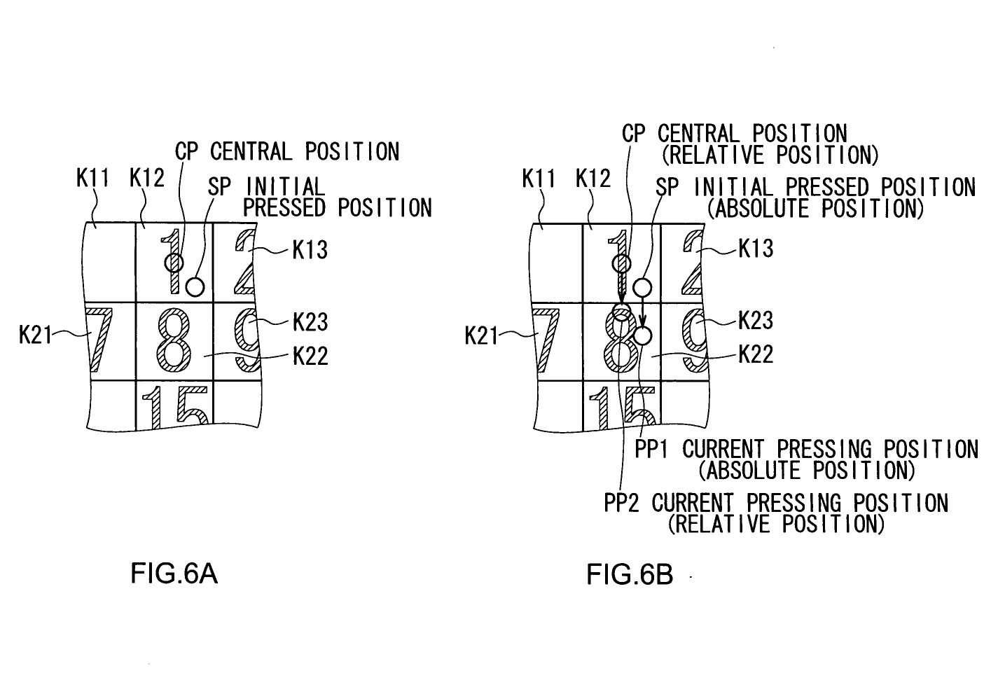

When the user actually presses a block K having a display region smaller than a fingertip, the user more often than not recognizes that he or she is pressing the center position of the block K. Therefore, the control section 10 is adapted to store not the initial pressed position SP that is the actually pressed position but the central position CP of the block K where the initial pressed position SP is found as shown in FIG. 6A in FirstPos to correspond to the recognition of the user. This will be described in greater detail in the description of the fingertip moving process sequence hereinafter.

After storing the central position of the block K indicated by the block number stored in LastIndex in FirstPos, the control section 10 proceeds to the next step, or Step SP4 (FIG. 5). In Step SP4, the control section 10 displays an enlarged block ZK that is an enlarged image of the block K indicated by the block number stored in LastIndex and subsequently goes to the end step, or Step SP5, to end the fingertip pressing process sequence RT1. The enlarged block ZK may be emphatically displayed by switching the color of the frame of the enlarged block ZK (e.g., red) with that of the frame of the block K (e.g., black).

In this way, the control section 10 recognizes the block K where the position pressed by the user by means of a fingertip is found and displays an enlarged block ZK that is an enlarged image of the block K by following the fingertip pressing process sequence RT1.

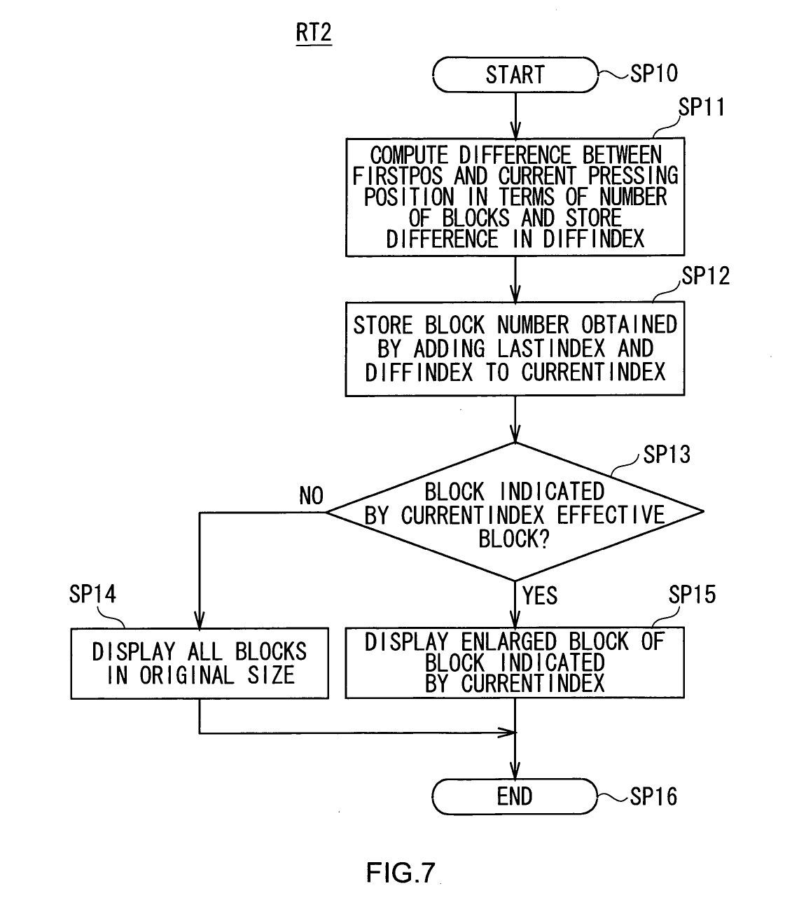

Now, the fingertip moving process sequence RT2 will be described below by referring to the flowchart of FIG. 7. As the control section 10 of the image viewing apparatus 1 recognizes by way of the touch panel controller 14 that the fingertip of the user that is pressing the touch panel 3B is moved, it starts the fingertip moving process sequence RT2 at Step SP10 and then proceeds to the next step, or Step SP11.

In Step SP11, the control section 10 performs an arithmetic operation of determining the difference between the central position stored in FirstPos and the position that is currently being pressed in terms of number of blocks K and stores the distance of move in terms of number of blocks K obtained as a result of the arithmetic operation in DiffIndex. More specifically, as shown in FIG. 6B, the control section 10 is adapted to recognize not the current pressing position PP1 that is an absolute position (e.g., the coordinates on the image) after the move relative to the initial pressed position SP, which is also an absolute position, but the current pressing position PP2 that is a relative position relative to the central position CP of the initial pressed position SP and computationally determines the difference between the central position CP and the current pressing position PP2 in terms of number of blocks K. With this arrangement, if the user presses an edge part of a block K by means of a fingertip, the control section 10 can make its operation match the recognition of the user that he or she presses the center of the block K.

After storing the distance of move in terms of number of blocks K in DiffIndex in this way, the control section 10 proceeds to the next step, or Step SP12 (FIG. 7). In Step SP12, the control section 10 stores the block number of the destination block of the move obtained by adding the block number before the move as stored in LastIndex and the distance stored in DiffIndex in CurrentIndex and then proceeds to the next step, or Step SP13.

In Step SP13, the control section 10 determines if there is an effective block K that corresponds to the block number stored in CurrentIndex or not. If the answer to the question is negative, it means that the block K that corresponds to the destination block number of the move is not an effective block K and hence the fingertip of the user has been moved to a block K that is other than the effective blocks K (and hence a block K where no numeral is shown, e.g., block K65). Then, the control section 10 recognizes that the user stops selecting a block K and proceeds to Step SP14.

In Step SP14, as shown in FIG. 3A, the control section 10 cancels the display of the enlarged block ZK and displays all the blocks K in the original size and goes to the end step, or Step SP16, to end the fingertip moving process sequence RT2.

If, on the other hand, the answer to the question in Step SP13 is positive, it means that the fingertip of the user has been moved from the effective block K that is selected first (e.g., block K12) to another effective block K (e.g., block K22). Then, the control section 10 recognizes that the user changed his or her selection of a block K and proceeds to Step SP15.

In Step SP15, the control section 10 cancels the display of the enlarged block ZK before the move and displays an enlarged block ZK of the destination block K of the move as indicated by the block number stored in CurrentIndex in place of the original enlarged block ZK. Then, the control section 10 goes to the end step, or Step SP16, to end the fingertip moving process sequence RT2.

In this way, the control section 10 cancels the display of the enlarged block ZK that corresponds to the block K before the move in response to the move of the fingertip and displays an enlarged block ZK that corresponds to the destination block K of the move in place of the cancelled display of the original enlarged block ZK by following the fingertip moving process sequence RT2.

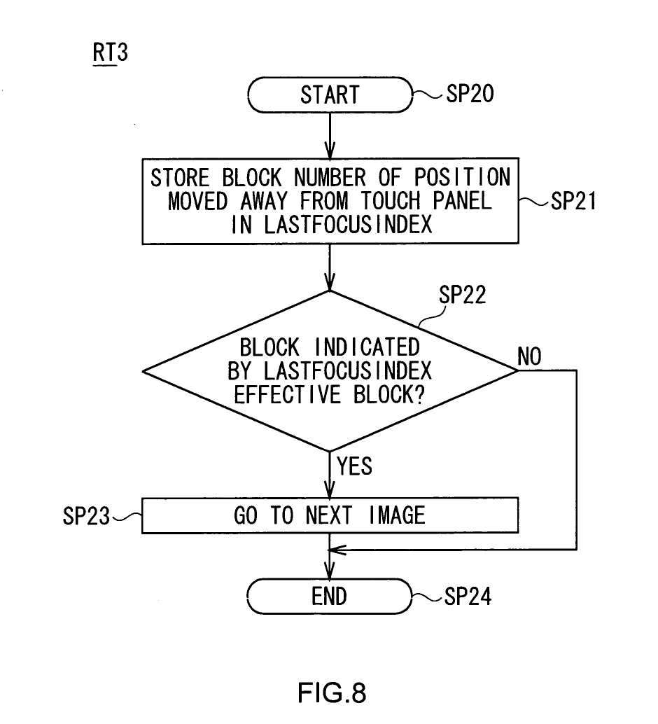

Now, the fingertip moving away process sequence RT3 will be described below by referring to the flowchart of FIG. 8. As the control section 10 of the image viewing apparatus 1 recognizes by way of the panel controller 14 that the fingertip of the user that is pressing the touch panel 3B is moved away from the touch panel 3B, it starts the fingertip moving away process sequence RT3 at Step SP20 and then proceeds to the next step, or Step SP21.

In Step SP21, the control section 10 stores the block number of the block K where the fingertip moving away position is found in LastFocusIndex and proceeds to the next step, or Step SP22. In Step SP22, the control section 10 determines if there is an effective block K that corresponds to the block number stored in LastFocusIndex or not. If the answer to the question is negative, it means that there is no effective block K at the position that had been pressed by a fingertip when the fingertip was moved away and hence the fingertip of the user used to press a block K other than the effective blocks K (and hence a block K where no numeral is shown, e.g., block K65) . Then, the control section 10 recognizes that the user does not select any block K and proceeds to Step SP14 to end the fingertip moving away process sequence RT3.

If, on the other hand, the answer to the question in Step SP22 is positive, it means that the fingertip of the user used to press an effective block K. Then, the control section 10 determines that the block K that corresponds to the block number stored in LastFocusIndex, e.g., block K22, is the block selected by the user and proceeds to Step SP23.

In Step SP23, the control section 10 retrieves the image data to which the date information corresponding to the block K22 (indicating May 8, 2005) is added from the hard disk drive 8 and displays the retrieved image data on the touch-panel-equipped-LCD 3 as image viewing image 21 showing thumbnail images as illustrated in FIG. 3E. Then, the control section 10 goes to the end step, or Step SP24, to end the fingertip moving away process sequence RT3.

In this way, the control section 10 determines that the block K where the position from which the fingertip of the user is moved away is found is the block K selected by the user and displays the image data to which the date information corresponding to the block K is added by following the fingertip moving away process sequence RT3.

(1-5) Operations and Effects of First Embodiment

In an image viewing apparatus 1 according to the embodiment of the present invention and having the above-described configuration, a total of 42 blocks K are arranged to form a matrix and a calendar image 20 where the days of the month are shown in up to 31 blocks K is displayed on the liquid crystal panel 3A.

Then, as the user presses the display region of one of the blocks K where numerals are shown (or the effective blocks K), e.g., block K12, by means of a fingertip and by way of the touch panel 3B, the image viewing apparatus 1 recognizes that the block K12 is selected by the user and displays an enlarged block ZK12 that is an enlarged image of the block K12 on the block K12 as a superimposed image.

As a result, if the display region of the block K12 has such a small size that it is hidden by the fingertip of the user that is pressing the block K12, the image viewing apparatus 1 displays an enlarged block ZK12 that is larger than the fingertip so that the user can easily realize what block K he or she is pressing currently.

Thereafter, as the user moves away the fingertip pressing the display region of the block K12 from the touch panel 3B, the image viewing apparatus 1 determines that the block K12 that has been pressed by the fingertip is the block K selected by the user. Then, the image viewing apparatus 1 reads out the image data to which the date information corresponding to the block K12 is added from the hard disk drive 8 and displays them as an image viewing image 21 on the liquid crystal panel 3A.

In this way, the image viewing apparatus 1 can perform all the operations from the operation of selecting a block K (date) through that of displaying image data that correspond to the block K in response to a single operation by the user of pressing the display region of a desired block K from the calendar image 20 by means of a fingertip and removing the fingertip. Such an image viewing operation is a very simple one to the user.

If, on the other hand, the fingertip pressing the display region of the block K12 is moved to the display region of some other block K, e.g., the block K22, without being moved away from the touch panel 3B, the image viewing apparatus 1 recognizes that the selected block K is changed from the block K12 to the block K22. Then, it cancels the enlarged block ZK12 and displays an enlarged block ZK22 that is an enlarged image of the block K22 on the block K22 as a superimposed image.

In this way, the image viewing apparatus 1 can perform all the operations necessary for changing the selected block K in response to a simple operation of moving the fingertip that is being pressed against the touch panel 3B. Such an image viewing operation is very simple to the user. Additionally, as an enlarged block ZK is displayed in response to a move of the fingertip so that the user can easily realize what block K he or she is currently selecting.

Thus, with the above-described arrangement, the user can realize with ease the block K he or she is pressing because an enlarged block ZK showing the block K selected by way of the touch panel 3B from the plurality of blocks K being displayed on the liquid crystal panel 3A is displayed on the panel 3A. Additionally, since a block K is selected by a single action of the user of pressing the touch panel 3B at the block K by means of a fingertip and the selection is finalized when the fingertip is moved away from the touch panel 3B, all the operations from the operation of selecting a block K through that of finalizing the selection are performed in response to a single operation by the user of pressing the touch panel 3B by means of a fingertip. Thus, it is possible to remarkably facilitate an input operation by way of the touch panel 3B and make it very easy for the user to operate the touch panel 3B regardless of the display area of each block K being displayed on the liquid crystal panel 3A.

### (2) Second Embodiment

Now, the second embodiment of the present invention will be described in detail below. Since the second embodiment is similar to the above-described first embodiment except that the image viewing operation of the image viewing apparatus 1 of this embodiment differs from that of the first embodiment, the description of the configuration of the image viewing apparatus 1 of this embodiment will be omitted.

(2-1) Image Viewing Operation

The image viewing apparatus 1 of the second embodiment is adapted to select a block K, finalize the selection and display the image data that correspond to the block K not in response to a single pressing action as in the case of the first embodiment but in response to a plurality of pressing actions. Now, the image viewing operation that requires a plurality of pressing actions will be described in detail below.

Firstly, the image viewing apparatus 1 displays a calendar image 20 showing 6 rows and 7 columns of blocks K, or a total of 42 blocks K, that are surrounded by black frames and numerals indicating the days of the month and filling up to 31 blocks K on the touch-panel-equipped-LCD 3.

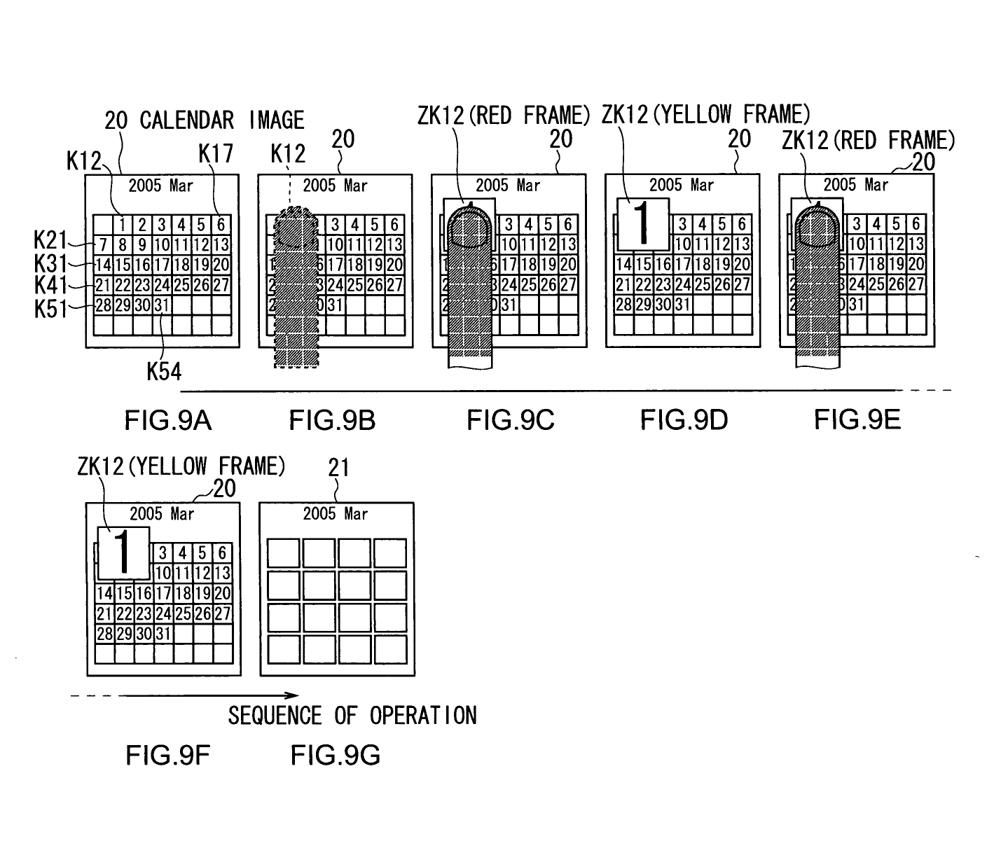

Note that the calendar images 20 of FIGS. 9A to 9G respectively correspond to March, 2005. Thus, “1” is filled in the block K12 to show the first of May and “2” is filled in the block K13 to show the second of May, while “6” is filled in the block K17 to show the sixth of May and “7” is filled in the block K21 to show the seventh of May. Similarly, “14” is filled in the block K31 to show the fourteenth of May and “21” is filled in the block K41 to show the twenty first of May, while “28” is filled in the block K51 to show the twenty eighth of May and “31” is filled in the block K54 to show the thirty first of May. In short, the blocks K12 through K54 are effective blocks K.

Then, as the user wants to select one of the effective blocks K, e.g., block K12 (the first), and presses the display region of the block K12 by means of a fingertip by way of the touch panel 3B, the image viewing apparatus 1 recognizes by way of the touch panel controller 14 that the display region is pressed and concentrically displays an enlarged block ZK12 that is an enlarged image of the block K12 with a red frame on the block K12 as a superimposed image on the touch-panel-equipped-LCD 3 as shown in FIG. 9C. Note that the display area of the enlarged block ZK12 is larger than the area of the finger pad of a finger of the user as described above by referring to the first embodiment.

After displaying the enlarged block ZK12 with a red frame, the user may move away the fingertip from the touch panel 3B as shown in FIG. 9D. Then, the image viewing apparatus 1 recognizes that the fingertip of the user is moved away from the touch panel 3B by way of the touch panel controller 14. However, the image viewing apparatus 1 keeps on displaying the enlarged block ZK12, changing the frame color from red to yellow. As the image viewing apparatus 1 keeps on displaying the enlarged block ZK12 even after the user moves away the fingertip from the touch panel 3B in this way, the user can reliably recognize that he or she currently selects the block K12 (the first).

Thereafter, the user presses the display region of the enlarged block ZK12 with the yellow frame that is being displayed by means of a fingertip as shown in FIG. 9E and then moves away the fingertip as shown in FIG. 9F. Then, as the image viewing apparatus 1 recognizes that the display region of the enlarged block ZK12 is pressed by a fingertip and subsequently the fingertip is moved away from the touch panel 3B by way of the touch panel controller 14, it determines that the block K12 (the first) that corresponds to the enlarged block ZK12 with the yellow frame is the block K selected by the user. In this way, the image viewing apparatus 1 can finalize the selection of the block K12 as the user presses the display region of the enlarged block ZK12 that is an enlarged image of the block K12. Therefore, it is possible to reliably avoid an operator error on the part of the user of pressing the display region of some other block K by mistake.

Then, the image viewing apparatus 1 retrieves the image data to which the date information corresponding to the block K12 (namely, May 1, 2005) is added from the hard disk drive 8 and displays the retrieved image data on the touch-panel-equipped-LCD 3 as image viewing image 21 showing thumbnail images as illustrated in FIG. 9G.

As described above, the image viewing apparatus 1 makes the user reliably recognize the block K he or she selects by displaying an enlarged block ZK in response to an action of pressing the block K and then finalizes the selection of the block K as the user presses the enlarged block ZK. With this arrangement, the image viewing apparatus 1 can make the user by far reliably select a block K and finalize the selection. Note that the operation of pressing a block K is referred to as selecting operation and the operation of pressing an enlarged block ZK is referred to as finalizing operation.

Now, assume that the user wants to select block K32 (the fifteenth) and tries to press the display region of the block K32 but he or she actually presses the display region of the block K12 (the first) that is arranged above the block K32 by two rows to select the block K12 by mistake. Then, the user operates for changing the selection of the block K.

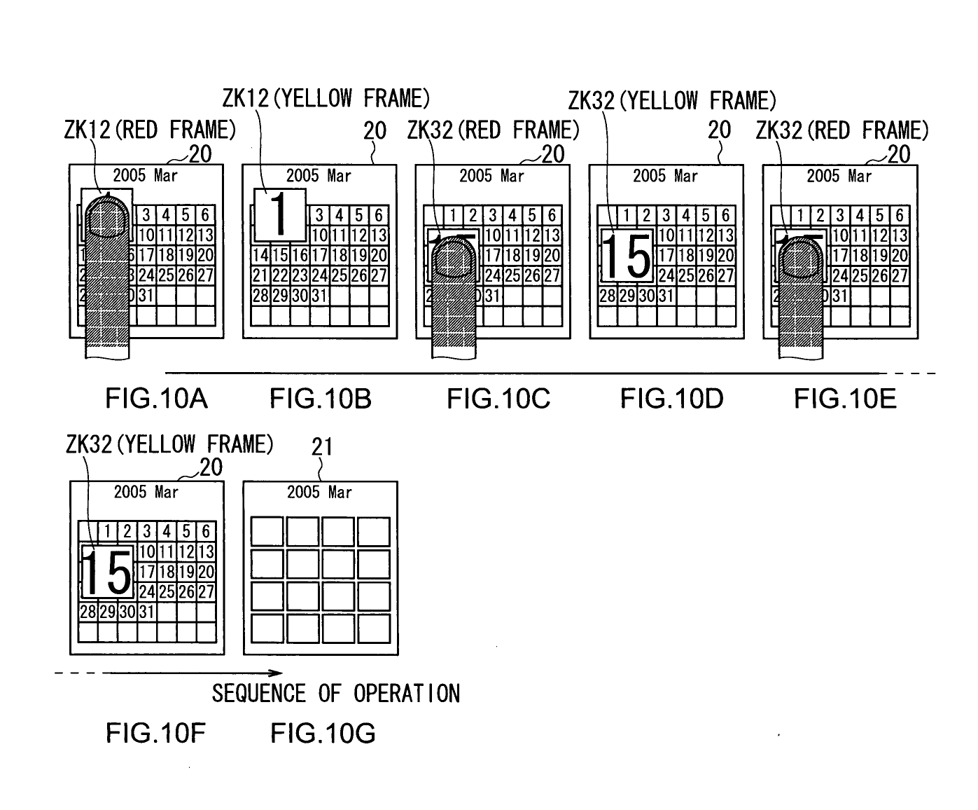

More specifically, the user recognizes that he or she has selected block K12 by mistake at the time when moving the fingertip pressing the touch panel 3 away from the latter because an enlarged block ZK12 is displayed as shown in FIG. 10B. Then, the user presses the display region of the block K32 as shown in FIG. 10C in order to correctly select the block K32.

Then, as a result, the image viewing apparatus 1 recognizes that the display region of the block K32 is pressed by a fingertip of the user by way of the touch panel controller 14 and cancels the display of the enlarged block ZK12 with a yellow frame. Then, it concentrically displays an enlarged block ZK32 that is an enlarged image of the block K32 with a red frame as a superimposed image on the touch-panel-equipped-LCD 3.

Thereafter, even when the image viewing apparatus 1 recognizes that the user has moved away the fingertip from the touch panel 3B by way of the touch panel controller 14 as shown in FIG. 10D, it keeps on displaying the enlarged block ZK32, changing the frame color from red to yellow. As the image viewing apparatus 1 switches the enlarged block ZK it displays from the enlarged block ZK12 to the enlarged block ZK32, the user can reliably recognize that the block K he or she selects is switched from the block K12 to the block K32.

Subsequently, as the image viewing apparatus 1 recognizes that the user presses the display region of the enlarged block ZK32 that is being displayed by means of a fingertip and by way of the touch panel 3B as shown in FIG. 10E and subsequently moves the fingertip away from the touch panel 3B as shown in FIG. 10F by way of the touch panel controller 14, it finalizes the selection by the user of the block K, which is the block K32 (the fifteenth) that corresponds to the enlarged block ZK32 being displayed.

Then, the image viewing apparatus 1 retrieves the image data to which the date information corresponding to the block K32 (or May 15, 2005) is added from the hard disk drive 8 and displays the retrieved image data on the touch-panel-equipped-LCD 3 as image viewing image 21 showing thumbnail images as illustrated in FIG. 10G.

In this way, the image viewing apparatus 1 is adapted to change the selection of a block K with ease in response to an action of pressing the block K for a plurality of times.

Meanwhile, if the user wants to select the block K22 (the eighth) and tries to press the display region of the block K22 but he or she actually presses the display region of the block K12 (the first) that is arranged on the row right above the row of the block K22 to select the block K12 by mistake, the display region of the block K 22 is hidden by the enlarged block ZK12 that is concentrically displayed on the block K12 so that the user is not able to press the display region of the block K22.

Therefore, after displaying the enlarged block ZK12 with a yellow frame, as the image viewing apparatus 1 recognizes that a predetermined time period has elapsed since the last touch by the user of the touch panel 3B by means of a fingertip, it cancels the display of the enlarged block ZK12 with the yellow frame to by turn cancel the selection of the block K12. Then, as a result, the user can now press the display region of the block K22 that has been hidden by the enlarged block ZK12.

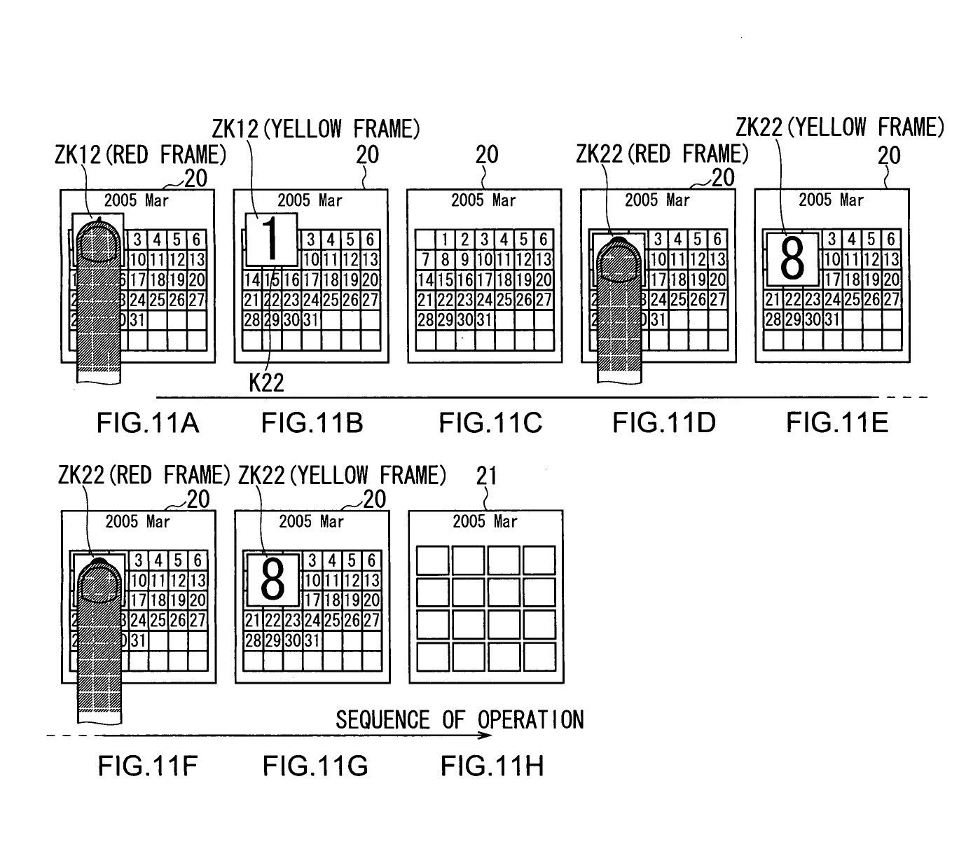

Then, as the image viewing apparatus 1 recognizes by way of the touch panel controller 14 that the user presses the display region of the block K22 by means of a fingertip and by way of the touch panel 3B, it concentrically displays an enlarged block ZK22 that is an enlarged image of the block K22 with a red frame as a superimposed image on the touch-panel-equipped-LCD 3 as shown in FIG. 11D.

After displaying the enlarged block ZK22 with the red frame in this way, even if the image viewing apparatus 1 recognizes that the fingertip of the user that has been pressing the touch panel 3 is moved away from the latter as shown in FIG. 11E by way of the touch panel controller 14, it keeps on displaying the enlarged block ZK22, changing the frame color from red to yellow. Thereafter, as the image viewing apparatus 1 recognizes that an operation of finalizing the selection of the block K22 is performed as shown in FIGS. 11F and 11G, it retrieves the image data to which the date information corresponding to the block K22 (or May 8, 2005) is added from the hard disk drive 8 and displays the retrieved image data on the touch-panel-equipped-LCD 3 as image viewing image 21 showing thumbnail images as illustrated in FIG. 11H.

In this way, the image viewing apparatus 1 is adapted to allow the user to press the display region of block K that has been hidden by an enlarged block ZK by canceling the display of the enlarged block ZK after the elapse of a predetermined time period so that the user may press the touch panel 3B once again after waiting for the predetermined time period.

Additionally, the image viewing apparatus 1 is also adapted to changing operations of switching the selected block K by moving the fingertip that is pressing the touch panel 3B described above by referring to the first embodiment.

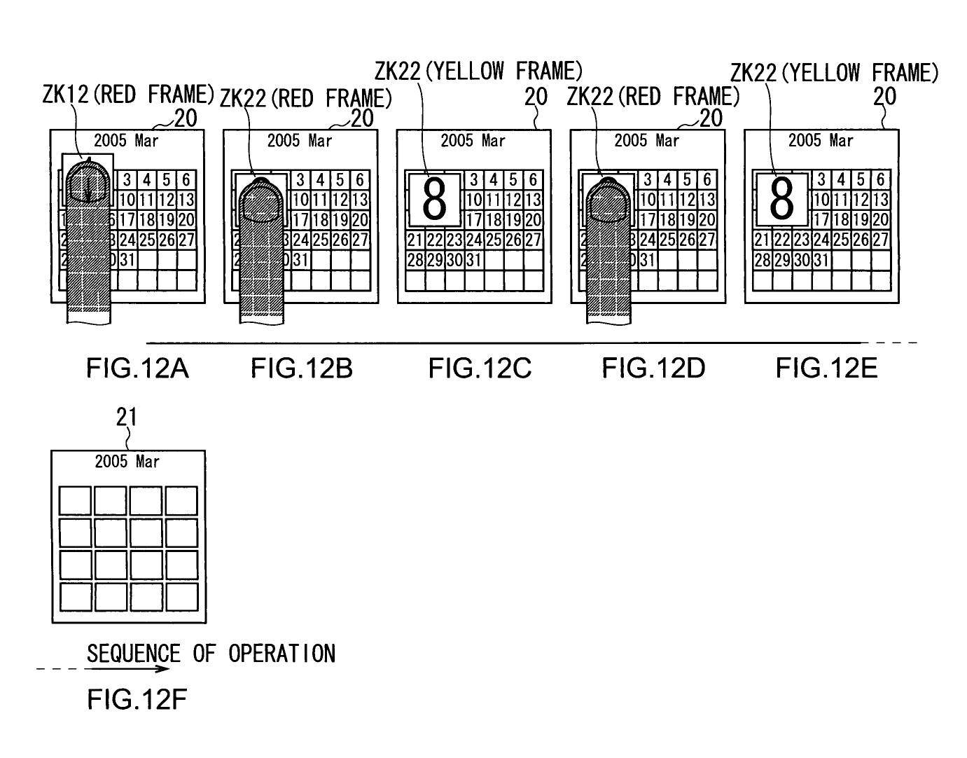

More specifically, when the user wants to select the block K22 (the eighth) and tries to press the display region of the block K22 but erroneously presses the display region of the block K12 (the first) that is on the row right above the row of the block K22 and selects the block K12 as shown in FIG. 12A, an enlarged block ZK12 is displayed with a red frame so that the user understands that he or she has erroneously selected the block K12 on the basis of the position displaying the enlarged block ZK12 with a red frame and part of the numeral “1” shown in the enlarged block ZK12. Then, the user moves the fingertip from the display region of the block K12 to the display region of the block K22, keeping the fingertip pressing the touch panel 3B.

Then, as a result, the image viewing apparatus 1 recognizes that the fingertip of the user is moved from the display region of the block K12 to the display region of the block K22. Then, it cancels the display of the enlarged block ZK12 with the red frame and, at the same time, displays an enlarged block ZK22 with a red frame, which is an enlarged image of the block K22, concentrically on the block K22 as a superimposed image in a manner as illustrated in FIG. 12B. As a result, the image viewing apparatus 1 can make the user assume with ease that the selected block K is moved from the block K12 to the block K22 or the selected block K is switched from the block K12 to the block K22.

After displaying the enlarged block ZK22 with a red frame, even when the image viewing apparatus 1 recognizes that the fingertip of the user is moved away from the touch panel 3B as shown in FIG. 12C by way of the touch panel controller 14, it keeps on displaying the enlarged block ZK22, changing the frame color from red to yellow. Thereafter, as the image viewing apparatus 1 recognizes that an operation of finalizing the selection of the block K22 is performed as shown in FIGS. 12D and 12E, it retrieves the image data to which the date information corresponding to the block K22 (or May 8, 2005) is added from the hard disk drive 8 and displays the retrieved image data on the touch-panel-equipped-LCD 3 as image viewing image 21 showing thumbnail images as illustrated in FIG. 12F.

In this way, the image viewing apparatus 1 is adapted to change the selection of a block K in response to a changing operation of moving the fingertip pressing the display region of a desired block K arranged in the calendar image 20.

(2-2) Operation Process Sequence of Image Viewing Operation

Now, the operation process sequence of the image viewing apparatus 1 in an image viewing operation will be described in greater detail in terms of the fingertip pressing process sequence that is followed when a fingertip is pressed, the fingertip moving process sequence that is followed when a pressing fingertip is moved and the fingertip moving away process sequence that is followed when the pressing fingertip is moved away. Note that the control section 10 of the image viewing apparatus 1 executes any of these operation process sequences according to the program installed in the ROM 11. As an example, the operation process sequence will be described below on an assumption that a calendar image 20 that corresponds to May, 2005is displayed on the touch-panel-equipped-LCD 3.

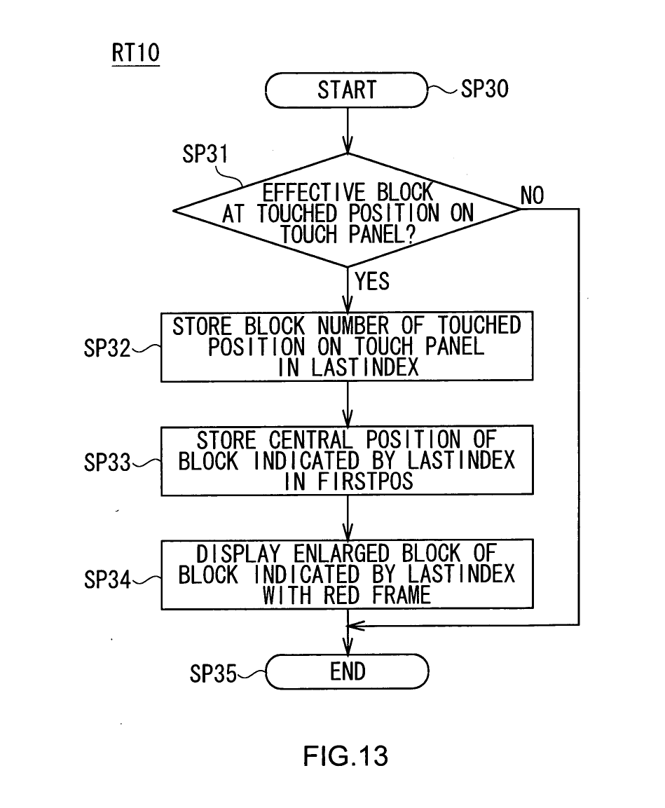

Firstly, the fingertip pressing process sequence RT10 will be described by referring to the flowchart of FIG. 13. Note that, in the following description, the variable storing the central position of the block K on the touch panel 3B that is located at the initial pressed position is expressed by FirstPos and the variable storing the block number of the block K where the initial pressed position is found is expressed by LastIndex, while the variable storing the distance by which the fingertip pressing the touch panel 3B is moved in terms of number of blocks and the variable storing the block number of the block where the position to which the fingertip pressing the touch panel 3B is moved is located (to be referred to as current pressing position hereinafter) are expressed respectively by DiffIndex and CurrentIndex and the variable storing the block number of the block where the fingertip moving away position on the display 3B is expressed by LastFocusIndex.

As shown in FIG. 13, as the control section 10 of the image viewing apparatus 1 recognizes by way of the touch panel controller 14 that the user presses the touch panel 3B by means of a fingertip, it starts the fingertip pressing process sequence RT10 at Step SP30 and then proceeds to the next step, or Step SP31.

In Step SP31, the control section 10 determines if there is an effective block K showing a numeral that indicates a date (which may be an enlarged block ZK with a yellow frame) that is found in the initial pressed position or not. If the answer to the question in Step SP31 is negative, it means that the user presses a part of the displayed image other than the effective blocks K (blocks K11 through K54 in the case of May, 2005). Then, the control section 10 determines that the user is not selecting an effective block and goes to Step SP35 to end the fingertip pressing process sequence RT10.

If, on the other hand, the answer to the question in Step SP31 is positive, it means that the user is selecting an effective block K and then the control section 10 proceeds to Step SP32.

In Step SP32, the control section 10 stores the block number of the block K or the enlarged block ZK with the yellow frame where the initial pressed position is found in LastIndex and proceeds to Step SP33. In Step SP33, the control section 10 stores the central position of the block K indicated by the block number stored in LastIndex in FirstPos.

After storing the central position of the block K indicated by the block number stored in LastIndex in FirstPos, the control section 10 proceeds to the next step, or Step SP34. In Step SP34, the control section 10 displays an enlarged block ZK with a red frame that is an enlarged image of the block K indicated by the block number stored in LastIndex and subsequently goes to the end step, or Step SP35, to end the fingertip pressing process sequence RT10.

In this way, the control section 10 recognizes the block K or the enlarged block ZK with a yellow frame where the initial pressed position pressed by the user by means of a fingertip is found and displays an enlarged block ZK with a red frame by following the fingertip pressing process sequence RT10.

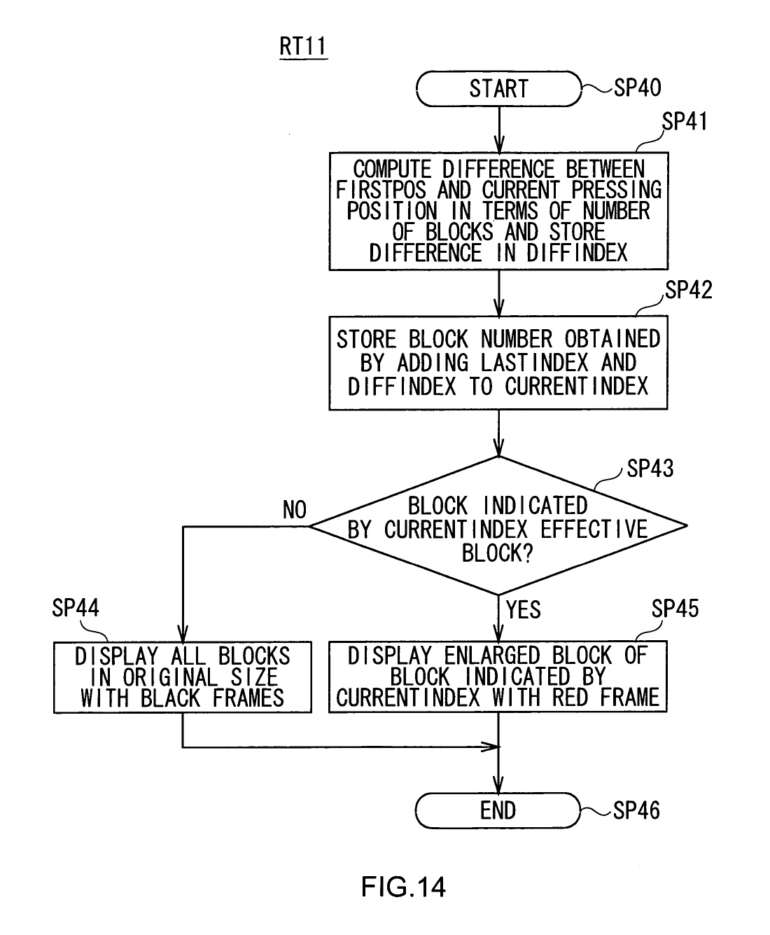

Now, the fingertip moving process sequence RT11 will be described below by referring to the flowchart of FIG. 14. As the control section 10 of the image viewing apparatus 1 recognizes by way of the touch panel controller 14 that the fingertip of the user that is pressing the touch panel 3B is moved, it starts the fingertip moving process sequence RT11 at Step SP40 and then proceeds to the next step, or Step SP41.

In Step SP41, the control section 10 performs an arithmetic operation of determining the difference between the central position stored in FirstPos and the position that is currently being pressed in terms of number of blocks K and stores the distance of move in terms of number of blocks K obtained as a result of the arithmetic operation in DiffIndex. More specifically, as shown in FIG. 6B as in the case of the first embodiment, the control section 10 is adapted to recognize not the current pressing position PP1 that is an absolute position (e.g., the coordinates on the image) after the move relative to the initial pressed position SP, which is also an absolute position, but the current pressing position PP2 that is a relative position relative to the central position CP of the initial pressed position SP and computationally determines the difference between the central position CP and the current pressing position PP2 in terms of number of blocks K. With this arrangement, if the user presses an edge part of a block K by means of a fingertip, the control section 10 can make its operation match the recognition of the user that he or she presses the center of the block K.

After storing the distance of move in terms of number of blocks K in DiffIndex in this way, the control section 10 proceeds to the next step, or Step SP42 (FIG. 14). In Step SP42, the control section 10 stores the block number of the destination block of the move obtained by adding the block number before the move as stored in LastIndex and the distance stored in DiffIndex in CurrentIndex and then proceeds to the next step, or Step SP43.

In Step SP43, the control section 10 determines if there is an effective block K that corresponds to the block number stored in CurrentIndex or not. If the answer to the question is negative, it means that the block K that corresponds to the destination block number of the move is not an effective block K and hence the fingertip of the user has been moved to a block K that is other than the effective blocks K (and hence a block K where no numeral is shown, e.g., block K65). Then, the control section 10 recognizes that the user stops selecting a block K and proceeds to Step SP44.

In Step SP44, the control section 10 cancels the display of the enlarged block ZK and displays all the blocks K in the original size with black frames and goes to the end step, or Step SP46, to end the fingertip moving process sequence RT11.

If, on the other hand, the answer to the question in Step SP43 is positive, it means that the fingertip of the user has been moved from the effective block K that is selected first (e.g., block K12) to another effective block K (e.g., block K22). Then, the control section 10 recognizes that the user changed his or her selection of a block K and proceeds to Step SP45.

In Step SP45, the control section 10 cancels the display of the enlarged block ZK, e.g., ZK12, which is an enlarged image of the block K before the move, or block K12, and displays an enlarged block ZK, e.g., ZK22, of the destination block K of the move, or block K22, as indicated by the block number stored in CurrentIndex with a red frame in place of the original enlarged block ZK12. Then, the control section 10 goes to the end step, or Step SP46, to end the fingertip moving process sequence RT11.

In this way, the control section 10 cancels the display of the enlarged block ZK with a red frame that corresponds to the block K before the move in response to the move of the fingertip and displays an enlarged block ZK that corresponds to the destination block K of the move with a red frame in place of the cancelled display of the original enlarged block ZK by following the fingertip moving process sequence RT11.

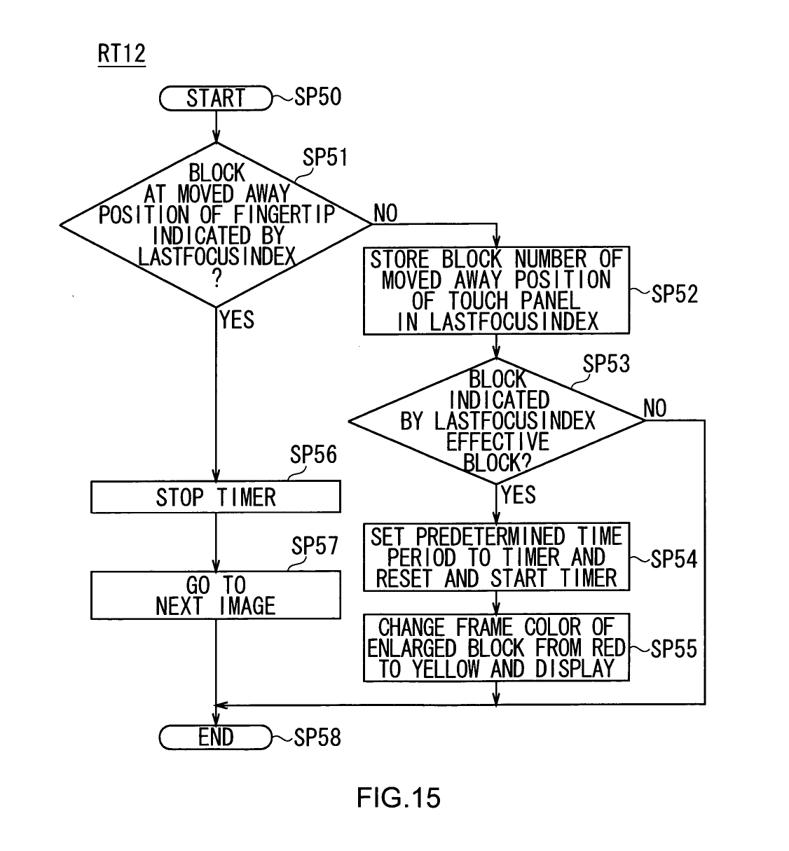

Now, the fingertip moving away process sequence RT12 will be described below by referring to the flowchart of FIG. 15. As the control section 10 of the image viewing apparatus 1 recognizes that the fingertip of the user that is pressing the touch panel 3B is moved away from the touch panel 3B, it starts the fingertip moving away process sequence RT12 at Step SP50 and then proceeds to the next step, or Step SP51.

In Step SP51, the control section 10 determines if the block number of the block K where the position from which the fingertip is moved away is found, or that of the enlarged block ZK with a red frame, is already stored in LastFocusIndex or not. Note that, it is so arranged for this embodiment that, when a block K is selected by means of a fingertip and the fingertip is moved away, the block number of the block K where the position from which the fingertip is moved away is located is stored in LastFocusIndex.

If the answer to the above question is negative, it means that the user has selected a block K by means of a fingertip and moved away the fingertip as shown in FIGS. 9D and 10D. Then, the control section 10 proceeds to Step SP52 (FIG. 15).

In Step SP52, the control section 10 stores the block number of the block K where the fingertip moving away position is found in LastFocusIndex and proceeds to the next step, or Step SP53. In Step SP53, the control section 10 determines if there is an effective block K that corresponds to the block number stored in LastFocusIndex or not. If the answer to the question is negative, it means that there is no effective block K at the position that had been pressed by a fingertip when the fingertip was moved away and hence the fingertip of the user used to press a block K other than the effective blocks K (and hence a block K where no numeral is shown, e.g., block K65). Then, the control section 10 recognizes that the user does not select any block K and proceeds to Step SP56 to end the fingertip moving away process sequence RT12.

If, on the other hand, the answer to the question in Step SP53 is positive, it means that the fingertip of the user used to press an effective block K. Then, the control section 10 proceeds to Step SP54. In Step SP54, the control section 10 sets a predetermined time period (e.g. 5 seconds) at the timer (not shown) contained in the cabinet 2 and resets the timer to make it start timing. Thereafter, the control section 10 proceeds to the next step, or Step SP55.

In Step SP55, the control section 10 changes the frame color of the enlarged block ZK that is being displayed from red to yellow and goes to the end step, or Step SP58, to end the fingertip moving away process sequence RT12.

If, on the other hand, the answer to the question at Step SP51 described above is positive, it means that the user selected a block K by means of a fingertip and then moved away the fingertip as shown in FIGS. 9F and 10F. Then, the control section 10 proceeds to Step SP56.

In Step SP56, the control section 10 determines that the block K that corresponds to the block number stored in LastFocusIndex, e.g., block K22, is the block K selected by the user and, at the same time, stops the timing of the timer. Then, it proceeds to the next step, or Step SP57.

In Step SP57, the control section 10 retrieves the image data to which the date information corresponding to the block K22 (indicating May 8, 2005) is added from the hard disk drive 8 and displays the retrieved image data on the touch-panel-equipped-LCD 3 as image viewing image 21 showing thumbnail images as illustrated in FIG. 9G. Then, the control section 10 goes to the end step, or Step SP58, to end the fingertip moving away process sequence RT12.

In this way, the control section 10 displays an enlarged block ZK with a yellow frame if the block K is selected by a fingertip moving away action of the user but finalizes the selection of the block K and displays the image data to which the date information corresponding to the block K is added if the selection of the block is finalized by a fingertip moving away action of the user.

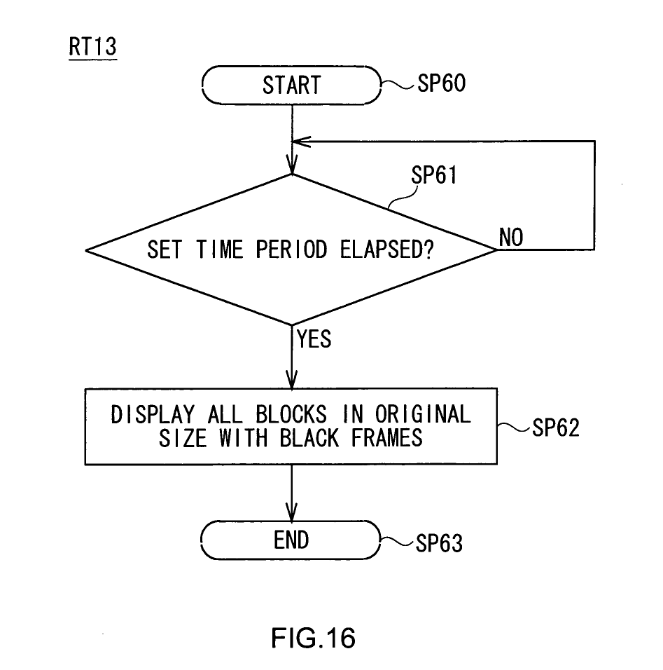

Additionally, if the answer to the question at Step SP51 of the fingertip moving away process sequence RT12 is negative and hence the timer has already started timing, the control section 10 starts following the timer process sequence RT13 at Step SP60 as illustrated in FIG. 16 after the end of the fingertip moving away process sequence RT12 and then proceeds to Step SP61.

In Step SP61, the control section 10 waits for the elapse of a predetermined and preset time period according to the reading of the timer. Thereafter, as the predetermined and preset time period elapses, the control section 10 proceeds to the next step, or Step SP62. In Step SP62, the control section 10 cancels the display of the enlarged block ZK and displays all the blocks K in the original size with black frames and goes to the end step, or Step SP63, to end the timer process sequence RT13.

In this way, as a predetermined period elapses after display an enlarged block ZK, the control section 10 cancels the display of the enlarged block ZK and also the selection of a block K. Note that the timer process sequence RT13 is a process sequence to be followed independently from the fingertip pressing process sequence RT10, the fingertip moving process sequence RT11 and the fingertip moving away process sequence RT12 that are described above.

(2-3) Operations and Effects of Second Embodiment

In an image viewing apparatus 1 according to the embodiment of the present invention and having the above-described configuration, a total of 42 blocks K are arranged to form a matrix and a calendar image 20 where the days of the month are shown in up to 31 blocks K is displayed on the liquid crystal panel 3A.

Then, as the user presses the display region of one of the blocks K where numerals are shown (or the effective blocks K), e.g., block K12, by means of a fingertip and by way of the touch panel 3B, the image viewing apparatus 1 recognizes that the block K12 is selected by the user and displays an enlarged block ZK12 that is an enlarged image of the block K12 on the block K12 with a red frame as a superimposed image.

Thereafter, as the user moves away the fingertip that is pressing the display region of the block K12 from the touch panel 3B, the image viewing apparatus 1 changes the frame color of the enlarged block ZK12 that is being displayed on the block K12 from red to yellow and keeps on displaying the enlarged block ZK12. As a result, the image viewing apparatus 1 can have the user who has moved away the fingertip reliably recognize that the block K12 is selected.

Subsequently, as the user presses the display region of the enlarged block ZK12 that is being displayed with a yellow frame by means of a fingertip and by way of the touch panel 3B and then moves away the fingertip from the touch panel 3B, the image viewing apparatus 1 finalizes the selection by the user of the block K12 that corresponds to the enlarged block ZK12 with the yellow frame. In this way, the image viewing apparatus 1 can finalize the selection of the block K12 by way of an action of pressing the enlarged block ZK12 that is an enlarged image of the block K12, it is possible to reliably prevent the user from pressing the display region of some other block K by mistake.

Then, the image viewing apparatus 1 reads out the image data to which the date information corresponding to the block K12 is added from the hard disk drive 8 and displays them as an image viewing image 21 on the liquid crystal panel 3A.

In this way, the image viewing apparatus 1 is adapted to have the user reliably recognize that he or she selects the block K by pressing the latter as it displays an enlarged block ZK and subsequently finalize the selection of the block K by having the user press the enlarged block ZK. With this arrangement, the image viewing apparatus 1 can allow the user a simple and reliable image viewing operation.

On the other hand, if the user presses the display region of the block K32 while the enlarged block ZK12 is being displayed with a yellow frame because the block K12 has been selected, the image viewing apparatus 1 recognizes that the selected block K is switched from the block K12 to the block K32 and displays an enlarged block ZK32 in place of the enlarged block ZK12.

In this way, the image viewing apparatus 1 can easily switch the selected block K in response to an action of pressing a block K that is different from the originally pressed block K.

Additionally, as the image viewing apparatus 1 recognizes that a predetermined time period has elapsed without any pressing action after displaying an enlarged block ZK12 with a yellow frame because the block K12 is selected, it stops displaying the enlarged block ZK12 with the yellow frame and cancels the selection of the block K12.

In this way, with the arrangement that the image viewing apparatus 1 cancels the selection of a block K after the elapse of a predetermined time period, the image viewing apparatus 1 can allow the user to change the selection of a block K in a simple manner and select a block K once again.

Additionally, if the touch panel 3B of the user that has been pressing the display region of a block K, e.g., block K12, is moved to the display region of the block K22 without leaving the touch panel 3B, the image viewing apparatus 1 recognizes that the selection of a block K is switched from the block K12 to the block K22 and displays an enlarged block ZK22 in place of the enlarged block ZK12.

In this way, the image viewing apparatus 1 can allow the user to change the selection of a block K with ease by means of a simple action of moving the fingertip that is pressing the touch panel 3B.

With the above-described arrangement, when one of the plurality of blocks K that are being displayed on the liquid crystal panel 3A is pressed, the image viewing apparatus 1 displays an enlarged block ZK that corresponds to the pressed block K to have the user recognize the block K he or she selects with ease and finalizes the selection in response to an action by the user of pressing the enlarged block ZK that is being displayed. Thus, it is possible to make it remarkably easy and reliable for the user to select a block K by means of the fingertip pressing the touch panel 3B regardless of the display area of each of the blocks K being displayed on the liquid crystal panel 3A and improve the efficiency of operation on the touch panel 3B.

### (3) Other Embodiments

When the user presses the display region of a block K on the touch-panel-equipped-LCD 3 of each of the above-described first and second embodiments by means of a fingertip, an enlarged block ZK that is an enlarged image of the block K adapted to operate as indicator for presentation is displayed on the block K as a superimposed image to notify the user of that the block K is selected by the user. However, the present invention is by no means limited thereto and any of various alternative notifying methods may be used for notifying the user.

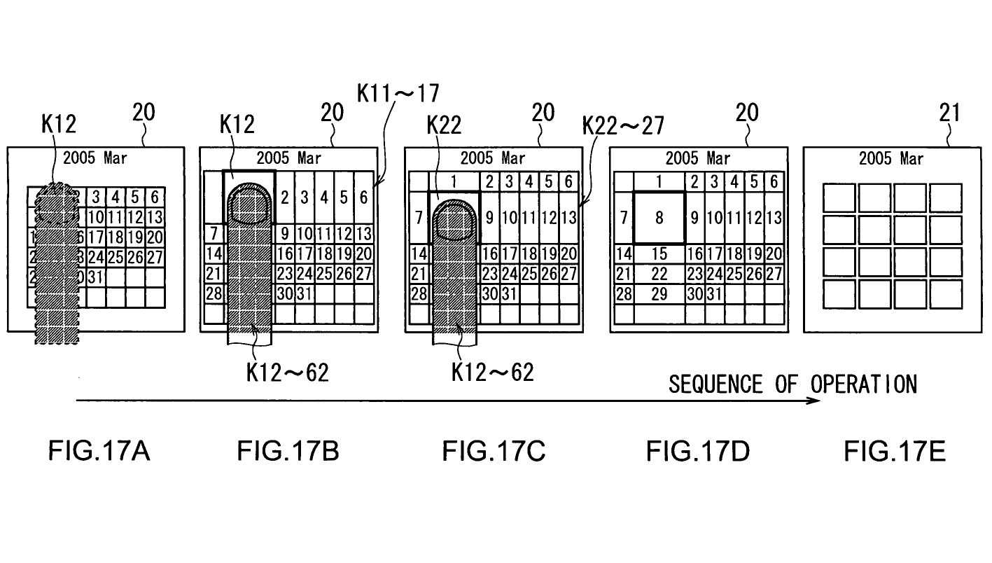

With an alternative notifying method, for example, as the image viewing apparatus 1 recognizes that the display region of the block K12 (the first) is pressed by the user by means of a fingertip, it enlarges the block K12 by extending both the length and the width of the display region of the block K12 to three times of the original dimensions and switches the frame color from black to yellow as shown in FIGS. 17A and 17B. At the same time, the image viewing apparatus 1 extends the length of the display region of each of the blocks K11, K13, K14, K15, K16 and K17 that are arranged on the row of the block K12 and hence on the transversal extension line of the block K12 to three times of the original dimension and also the width of the display region of each of the blocks K22, K32, K42, K52 and K62 that are arranged on column of the block K12 and hence on the longitudinal extension line of the block K12 to three times of the original dimension.

In this way, the image viewing apparatus 1 enlarges the display regions of the blocks K of the first row and those of the blocks K of the second columns so as to have the user recognize with ease that the block K12 that is located at the crossing of the first row and the second column is selected.

Additionally, as the image viewing apparatus 1 recognizes that the fingertip of the user that has been pressing the display region of the block K12 is moved to the display region of the block K22 (the eighth), for example, as shown in FIG. 17C, it then enlarges the block K22 by extending both the length and the width of the display region of the block K22 to three times of the original dimensions and switches the frame color from black to yellow. At the same time, the image viewing apparatus 1 extends the length of the display region of each of the blocks K21, K23, K24, K25, K26 and K27 that are arranged on the row of the block K22 and hence on the transversal extension line of the block K22 to three times of the original dimension and also the width of the display region of each of the blocks K12, K32, K42, K52 and K62 that are arranged on the column of the block K22 and hence on the longitudinal extension line of the block K22 to three times of the original dimension. Additionally, at this time, the image viewing apparatus 1 reduces the size of the display region of each of the blocks K11, K13, K14, K15, K16 and K17 to the original dimensions and brings back the frame color of the block K12 from yellow to black.

In this way, the image viewing apparatus 1 enlarges the blocks K on the second row and the blocks K on the second column so as to have the user recognize with ease that the block K22 that is located at the crossing of the second row and the second column is selected and hence the selected block K is switched from the block K12 to the block K22.

Still additionally, as the fingertip is moved away from the above position (FIG. 17D), the image viewing apparatus 1 determines that the selection by the use of the block K22 is finalized and displays the image data that correspond to the block K22 as image viewing image 21 (FIG. 17E). While the selection of a block K is switched by means of a move of a fingertip in the above description, the present invention is by no means limited thereto and the selection of a block K may be switched by means of a plurality of fingertip pressing actions as in the case of the above-described second embodiment.

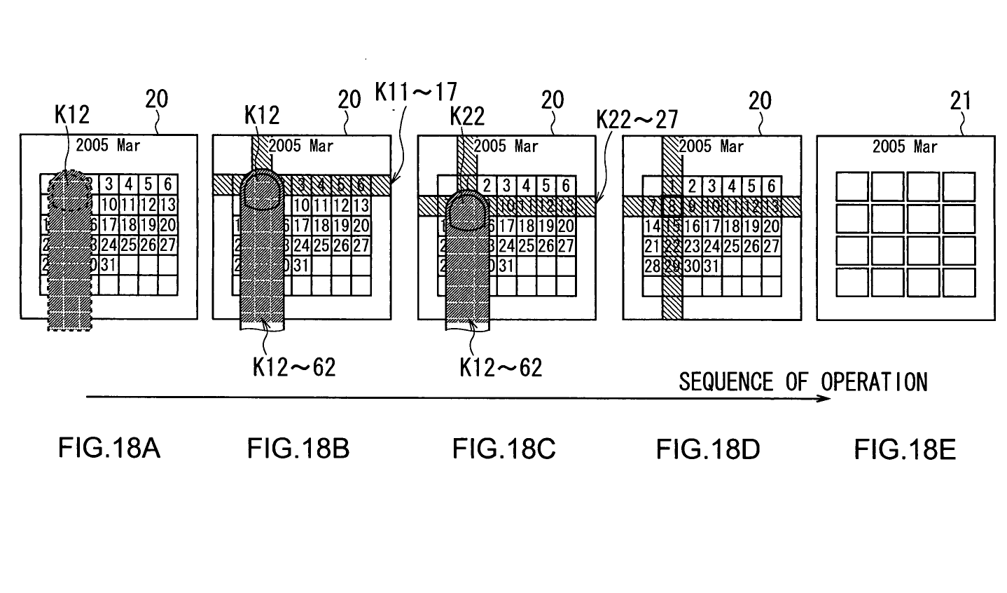

With another alternative notifying method, as the image viewing apparatus 1 recognizes that the display region of the block K12 (the first) is pressed by the user by means of a fingertip, it changes the display color and the frame color of the block K12 respectively from white and black to yellow and red as shown in FIGS. 18A and 18B and, at the same time, it also changes the display color of each of the blocks K11, K13, K14, K15, K16 and K17 that are arranged on the row of the block K12 and hence on the transversal extension line of the block K12 and the blocks K22, K32, K42, K52 an K62 that are arranged on column of the block K12 and hence on the longitudinal extension line of the block K12 from white to yellow.

In this way, the image viewing apparatus 1 changes the display color of the blocks K on the first row and that of the blocks K on the second column so as to have the user recognize with ease that the block K12 that is located at the crossing of the first row and the second column is selected.

Additionally, as the image viewing apparatus 1 recognizes that the fingertip of the user that has been pressing the display region of the block K12 is moved to the display region of the block K22 (the eighth), for example, as shown in FIG. 18C, it then displays the block K22 in yellow and changes the frame color from black to red. At the same time, the image viewing apparatus 1 changes the display color of each of the blocks K21, K23, K24, K25, K26 and K27 that are arranged on the row of the block K22 and hence on the transversal extension line of the block K22 from white to yellow and also the display color of each of the blocks K12, K32, K42, K52 and K62 that are arranged on the column of the block K22 and hence on the longitudinal extension line of the block K22 from white to yellow. Additionally, at this time, the image viewing apparatus 1 brings back the display color and the frame color of each of the blocks K11, K13, K14, K15, K16 and K17 respectively to the original white color and from red to black.

In this way, the image viewing apparatus 1 changes the display color of each of the blocks K on the first row and the blocks K on the second column so as to have the user recognize with ease that the block K12 that is located at the crossing of the first row and the second column is selected and hence the selected block K is switched from the block K12 to the block K22.

Still additionally, as the fingertip is moved away from the above position (FIG. 18D), the image viewing apparatus 1 determines that the selection by the user of the block K22 is finalized and displays the image data that correspond to the block K22 as image viewing image 21 (FIG. 18E). While the selection of a block K is switched by means of a move of a fingertip in the above description, the present invention is by no means limited thereto and the selection of a block K may be switched by means of a plurality of fingertip pressing actions as in the case of the above-described second embodiment.

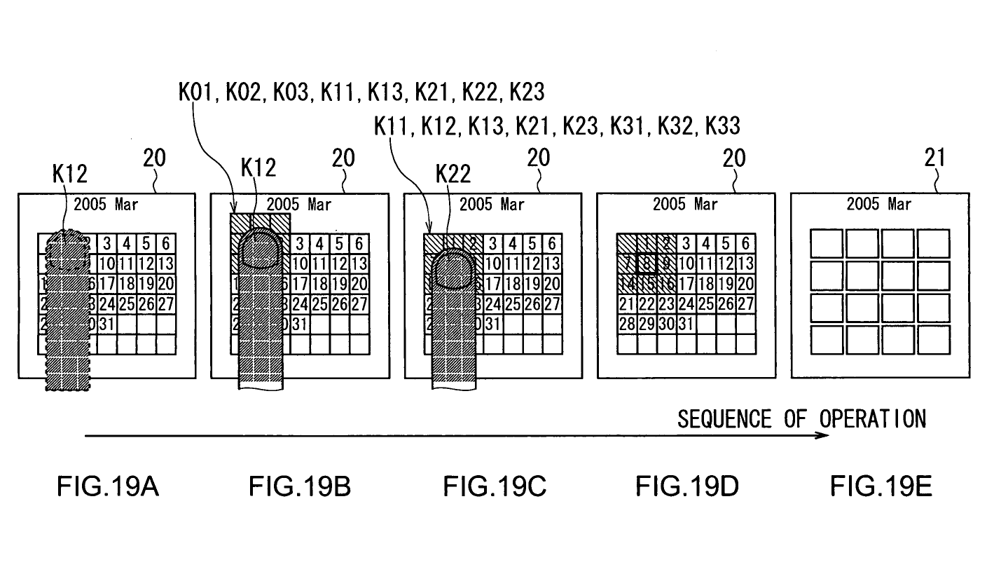

With still another alternative notifying method, as the image viewing apparatus 1 recognizes that the display region of the block K12 (the first) is pressed by the user by means of a fingertip, it changes the display color and the frame color of the block K12 respectively from white and black to yellow and red as shown in FIGS. 19A and 19B and, at the same time, it also changes the display color of each of the blocks K11, K13, K21, K22 and K23 that are arranged adjacent to the block K12 from white to yellow and, assuming that blocks K01 through K07 are arranged on the row immediately above the block K12 (i.e., the 0-th row), additionally the display color of the blocks K01, K02 and K03 that are arranged adjacent to the block K12 from white to yellow. In short, the image viewing apparatus 1 changes the display color of the block K12 to yellow and, at the same time, the display color of each of the surrounding eight blocks that are located adjacent to the block K12 to yellow.

In this way, the image viewing apparatus 1 has the user recognize with ease that the block K12 located at the center of the nine blocks K whose display color is changed to yellow is selected.

Additionally, as the image viewing apparatus 1 recognizes that the fingertip of the user that has been pressing the display region of the block K12 is moved to the display region of the block K22 (the eighth), for example, as shown in FIG. 19C, it then displays the block K22 in yellow and changes the frame color from black to red. At the same time, the image viewing apparatus 1 changes the display color of each of the blocks K11, K12, K13, K21, K23, K31, K32 and K33 that are arranged adjacent to the block K22 to yellow. Additionally, at this time, the image viewing apparatus 1 brings back the display color of each of the blocks K01, K02 and K03 to the original color and the frame color of the block K12 from red to black.

In this way, the image viewing apparatus 1 changes the display color of the block K22 to yellow and, at the same time, the display color of each of the surrounding eight blocks K that are located adjacent to the block K22 also to yellow so as to have the user recognize with ease that the block K22 that is located at the center of the nine blocks K whose display color is changed to yellow is selected and hence the selected block K is switched from the block K12 to the block K22.

Still additionally, as the fingertip is moved away from the above position (FIG. 19D), the image viewing apparatus 1 determines that the selection by the user of the block K22 is finalized and displays the image data that correspond to the block K22 as image viewing image 21 (FIG. 19E). While the selection of a block K is switched by means of a move of a fingertip in the above description, the present invention is by no means limited thereto and the selection of a block K may be switched by means of a plurality of fingertip pressing actions as in the case of the above-described second embodiment. Additionally, while the display color of each of the surrounding eight blocks (adjacent to the block in question in the longitudinal, transversal and oblique directions) is changed, the display color of surrounding four blocks (adjacent to the block in question in the longitudinal and transversal directions) may alternatively be changed.

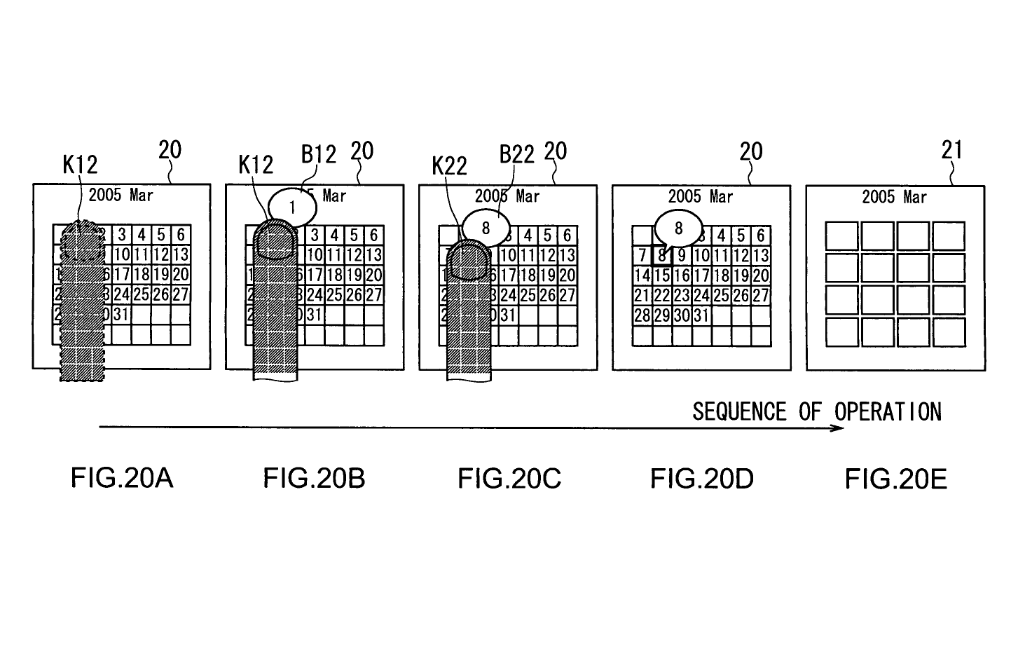

With still another alternative notifying method, as the image viewing apparatus 1 recognizes that the display region of the block K12 (the first) is pressed by the user by means of a fingertip, it displays a balloon B12 as indicator for presentation for indicating the display region of the block K12 near the display region of the block K12 as shown in FIGS. 20A and 20B. The balloon B12 shows numeral “1” that is same as the numeral “1” in the block K12 at a position that may be not hidden by the fingertip pressing the touch panel 3B.

In this way, the image viewing apparatus 1 has the user recognize with ease that the block K12 is selected by means of a balloon B12.

Additionally, as the image viewing apparatus 1 recognizes that the fingertip of the user that has been pressing the display region of the block K12 is moved to the display region of the block K22 (the eighth), for example, as shown in FIG. 20C, it then displays a balloon B22 indicating the display region of the block K22 and showing numeral “8” that is same as the numeral “8” in the block K22 at a position near the display region of the block K22. At the same time, the image viewing apparatus 1 stops displaying the balloon B12.

In this way, the image viewing apparatus 1 has the user recognize that the block K22 is selected this time and hence the selected block K is switched from the block K12 to the block K22 by means of a balloon B22.

Still additionally, as the fingertip is moved away from the above position (FIG. 20D), the image viewing apparatus 1 determines that the selection by the user of the block K22 is finalized and displays the image data that correspond to the block K22 as image viewing image 21 (FIG. 20E). While the selection of a block K is switched by means of a move of a fingertip in the above description, the present invention is by no means limited thereto and the selection of a block K may be switched by means of a plurality of fingertip pressing actions as in the case of the above-described second embodiment.

With still another alternative notifying method, the image viewing apparatus 1 may notify the user that a block K is selected by means of sounds or by displaying character information indicating that the currently selected block K (date) in an empty display region in the calendar image 20.

While the present invention is applied to an image viewing apparatus 1 for viewing image data in the above-described first and second embodiments, the present invention is by no means limited thereto and may also be applied to various apparatus of different types such as PDAs, portable game machines, portable telephone sets, digital still cameras, ticket vending machines and remote controllers so long as they include a touch panel as input operation device.

Additionally, while the user uses a fingertip as pointer for operating the touch panel 3B in the above description of the first and second embodiments, the present invention is by no means limited thereto and some other pointer such as a pencil, a rod or a dedicated touch pen may alternatively be used so long as it can be used to operate the touch panel.

In the first and second embodiments, it is described that a block K arranged to form a matrix on a calendar image 20 is used as an indicator that the user can select. However, the present invention is by no means limited thereto and an electronic program listing, various icons, various buttons or the like may be alternatively used so long as it can be operated as an indicator that can be displayed on the liquid crystal panel 3B and used for selection.

Further, in the first and second embodiments, it is described that the touch panel 3B of the electrostatic capacity type is used. However, the present invention is by no means limited thereto and a touch panel of any other type may be used such as a touch panel of pressure sensitive type.

While the second embodiment is described above so as to provide two patterns of operation including one for switching the selection of a block K by pressing the touch panel a plurality of times and one for switching the section of a block K by moving a fingertip, the present invention is by no means limited thereto. In other words, the display apparatus may provide only one of the two patterns of operation or may be adapted to switch from a switching mode of pressing the touch panel a plurality of times to another mode of moving a fingertip or vice versa.

Still additionally, while the image viewing apparatus 1 of both the above-described first and second embodiments of display apparatus includes a liquid crystal panel 3A that operates as display section, a touch panel 3B, a control section 10 that operates both as display control section and notifier section and an LCD controller 13 that operates as display control section, the present invention is by no means limited thereto and may have any alternative components so long as they make the display apparatus operate properly for the purpose of the present invention.

Furthermore, while the control section 10 executes fingertip pressing processes, fingertip moving processes, fingertip moving away processes and timer processes as software according to the program installed in the image viewing apparatus 1 in the above-described first and second embodiments, the present invention is by no means limited thereto and, alternatively, a circuit for executing such processes may be arranged in the image viewing apparatus 1 so as to operate as hardware. Still alternatively, a program for executing fingertip pressing processes, fingertip moving processes, fingertip moving away processes and timer processes may be recorded on a recording medium such as a CD.

Thus, it is possible find a broad scope of application in electronic apparatus that uses a touch panel as input operation device.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus comprising:
a display section;
a touch panel arranged on the display surface of the display section to allow the user to specify a desired position on a displayed image being displayed on the display section by pressing a pointer against it;
a display control section that causes a plurality of indicators to be displayed on the display section so as to allow the user to select one of them by way of the touch panel; and
a notifier section that notifies the user of the indicator selected from the plurality of indicators; wherein
the notifier section being adapted to notify the user of the selection of one of the indicators when the indicator of plurality of indicators being displayed on the display section is selected by pressing the pointer against the touch panel, and
the display control section being adapted to finalize the selection by the user of said one of the indicators when the pointer selecting the indicator is moved away from the touch panel after selecting it by being pressed against the touch panel.

2. The apparatus according to claim 1, wherein
as said one of the indicators is selected by pressing the pointer against the touch panel, the notifier section causes the display control section to display an indicator for presentation for the purpose of showing the user that the indicator is selected.

3. The apparatus according to claim 1, wherein
as the pointer selecting said one of the indicators is moved away from the touch panel under the condition where said one of the indicators is selected by pressing the pointer against the touch panel and the indicator for presentation is displayed and subsequently the indicator for presentation being displayed on the display section is selected by pressing the pointer against the touch panel, the display control section finalizes the selection by the user of said one of the indicators being shown by the indicator for presentation.

4. The apparatus according to claim 1, wherein
as said one of the indicators is selected by pressing the pointer against the touch panel and subsequently the pointer is moved to another one of the indicators, while being pressed against the touch panel, the display control section recognizes that the selected indicator is switched to the another one of the indicators and, as the pointer selecting the another one of the indicator is moved away from the touch panel, the display control section finalizes the selection by the user of the another one of the indicators.

5. The apparatus according to claim 4, wherein
as the pointer is moved, while being pressed against the touch panel, the display control section converts the absolute position where the pointer is actually pressed to a relative position where the user recognizes as the position being pressed by the pointer and recognizes the move of the pointer according to the relative position.

6. The apparatus according to claim 2, wherein
the notifier section has the indicator for presentation to be displayed with a display area larger than the selected one of the indicators as an image superimposed on said one of the indicators.

7. The apparatus according to claim 2, wherein
the notifier section has the indicator for presentation to be displayed at a position different from the selected one of the indicators.

8. The apparatus according to claim 1, wherein
the display control section has the plurality of indicators arranged in the form of a matrix and displayed on the display section; and
as one of the plurality of indicators displayed on the display section is selected as a result of pressing the pointer against the touch panel, the notifier section has the display control section enlarge the selected one of the indicators, the indicators on the row of the selected one of the indicators and the indicators on the column of the selected one of the indicators and display on the display section.

9. The apparatus according to claim 1, wherein
the display control section has the plurality of indicators arranged in the form of a matrix and displayed on the display section; and
as one of the plurality of indicators displayed on the display section is selected as a result of pressing the pointer against the touch panel, the notifier section has the display control section display the selected one of the indicators, the indicators on the row of the selected one of the indicators and the indicators on the column of the selected one of the indicators in a display color different from the remaining indicators on the display section.

10. The apparatus according to claim 1, wherein
the display control section has the plurality of indicators arranged in the form of a matrix and displayed on the display section; and
as one of the plurality of indicators displayed on the display section is selected as a result of pressing the pointer against the touch panel, the notifier section has the display control section display the selected one of the indicators and the indicators located adjacent to the selected one of the indicators in a display color different from the remaining indicators on the display section.

11. A display method comprising:
a display step of causing a plurality of indicators to be displayed on a display section so as to allow the user to select one of them by way of a touch panel;
a notification step of notifying the user of the selected one of the indicators in response to the selection of the one of the plurality of indicators by pressing a pointer against the touch panel; and
a finalization step of finalizing the selection of said one of the indicators in response to an action of moving the pointer selecting said one of the indicators from the touch panel.
